(19) United States
(12) Patent Application Publication
(10) Pub. No.: US 2013/0081050 A1
(43) Pub. Date: Mar. 28, 2013

(54) Acquiring and transmitting tasks and subtasks to interface devices

(71) Applicants: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(72) Inventors: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(73) Assignee: Elwha LLC, a limited liability company of the State of Delaware

(21) Appl. No.: 13/373,829

(22) Filed: Nov. 30, 2011

Related U.S. Application Data
(63) Continuation-in-part of application No. 13/200,553, filed on Sep. 23, 2011.
Application No. 13/200,553 is a continuation-in-part of application No. 13/200,797, filed on Sep. 30, 2011.
Application No. 13/200,797 is a continuation of application No. 13/373,826, filed on Nov. 30, 2011.
Application No. 13/373,826 is a continuation-in-part of application No. 13/317,591, filed on Oct. 21, 2011.
Application No. 13/373,826 is a continuation-in-part of application No. 13/317,833, filed on Oct. 28, 2011.
Application No. 13/317,833 is a continuation-in-part of application No. 13/373,795, filed on Nov. 29, 2011.
Application No. 13/373,795 is a continuation-in-part of application No. 13/373,794, filed on Nov. 29, 2011.

(51) Int. Cl. G06F 9/46; G06F 15/16

(52) U.S. Cl. 718/106

(57) ABSTRACT

Computationally implemented methods and systems include acquiring one or more subtasks that correspond to portions of a task of acquiring data requested by a task requestor, wherein the task of acquiring data is configured to be carried out by two or more discrete interface devices, transmitting at least one of the one or more subtasks to at least two of the two or more discrete interface devices, wherein the one or more subtasks are configured to be carried out in an absence of information regarding the task requestor and/or the task of acquiring data, and receiving result data corresponding to a result of an executed one or more subtasks. In addition to the foregoing, other aspects are described in the claims, drawings, and text.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

For purposes of the USPTO extra-statutory requirements, the present application constitutes a continuation-in-part of U.S. patent application Ser. No. 13/200,553, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 23, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/200,797, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 21, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 28, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled METHODS AND DEVICES FOR RECEIVING AND EXECUTING SUBTASKS, naming Royce A. Levien; Richard T. Lord; Robert W. Lord; Mark A. Malamud; and John D. Rinaldo, Jr., as inventors, filed Nov. 29, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled METHODS AND DEVICES FOR RECEIVING AND EXECUTING SUBTASKS, naming Royce A. Levien; Richard T. Lord; Robert W. Lord; Mark A. Malamud; and John D. Rinaldo, Jr., as inventors, filed Nov. 29, 2011, which is currently co-pending, or is an application of which a currently co-pending application is entitled to the benefit of the filing date.

### BACKGROUND

This application is related to using interface devices to collect data.

### SUMMARY

A computationally implemented method includes, but is not limited to acquiring one or more subtasks that correspond to portions of a task of acquiring data requested by a task requestor, wherein the task of acquiring data is configured to be carried out by two or more discrete interface devices, transmitting at least one of the one or more subtasks to at least two of the two or more discrete interface devices, wherein the one or more subtasks are configured to be carried out in an absence of information regarding the task requestor and/or the task of acquiring data, and receiving result data corresponding to a result of an executed one or more subtasks. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware in one or more machines or article of manufacture configured to effect the herein-referenced method aspects depending upon the design choices of the system designer.

A computationally implemented system includes, but is not limited to means for acquiring one or more subtasks that correspond to portions of a task of acquiring data requested by a task requestor, wherein the task of acquiring data is configured to be carried out by two or more discrete interface devices, means for transmitting at least one of the one or more subtasks to at least two of the two or more discrete interface devices, wherein the one or more subtasks are configured to be carried out in an absence of information regarding the task requestor and/or the task of acquiring data, and means for receiving result data corresponding to a result of an executed one or more subtasks.

A computationally implemented system includes, but is not limited to circuitry for acquiring one or more subtasks that correspond to portions of a task of acquiring data requested by a task requestor, wherein the task of acquiring data is configured to be carried out by two or more discrete interface devices, circuitry for transmitting at least one of the one or more subtasks to at least two of the two or more discrete interface devices, wherein the one or more subtasks are configured to be carried out in an absence of information regarding the task requestor and/or the task of acquiring data, and circuitry for receiving result data corresponding to a result of an executed one or more subtasks.

A computer program product comprising an article of manufacture bears instructions including but not limited to one or more instructions for acquiring one or more subtasks that correspond to portions of a task of acquiring data requested by a task requestor, wherein the task of acquiring data is configured to be carried out by two or more discrete interface devices, one or more instructions for transmitting at least one of the one or more subtasks to at least two of the two or more discrete interface devices, wherein the one or more subtasks are configured to be carried out in an absence of information regarding the task requestor and/or the task of acquiring data, and one or more instructions for receiving result data corresponding to a result of an executed one or more subtasks.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1, including FIGS. 1A and 1B, shows a high-level block diagram of an interface device operating in an exemplary environment 100, according to an embodiment.

FIG. 2A, including FIGS. 2A1 through 2A3, shows a particular perspective of the task portion two-or-more discrete interface device subtask acquiring module 52 of the computing device 30 of environment 100 of FIG. 1.

FIG. 2B, including FIGS. 2B1 through 2B3, shows a particular perspective of absent knowledge of task and/or task requestor information subtask transmitting module 54 of the computing device 30 of environment 100 of FIG. 1.

FIG. 3, including FIGS. 3A-3F, shows a particular perspective of the executed subtask result data receiving module 56 of the computing device 30 of environment 100 of FIG. 1.

FIG. 4 is a high-level logic flowchart of a process, e.g., operational flow 400, according to an embodiment.

FIG. 5A is a high-level logic flowchart of a process depicting alternate implementations of an acquiring one or more subtasks operation 402 of FIG. 4.

FIG. 5B is a high-level logic flowchart of a process depicting alternate implementations of an acquiring one or more subtasks operation 402 of FIG. 4.

FIG. 5C is a high-level logic flowchart of a process depicting alternate implementations of an acquiring one or more subtasks operation 402 of FIG. 4.

FIG. 6A is a high-level logic flowchart of a process depicting alternate implementations of a transmitting at least one of the one or more subtasks operation 404 of FIG. 4.

FIG. 6B is a high-level logic flowchart of a process depicting alternate implementations of a transmitting at least one of the one or more subtasks operation 404 of FIG. 4.

FIG. 6C is a high-level logic flowchart of a process depicting alternate implementations of a transmitting at least one of the one or more subtasks operation 404 of FIG. 4.

FIG. 6D is a high-level logic flowchart of a process depicting alternate implementations of a transmitting at least one of the one or more subtasks operation 404 of FIG. 4.

FIG. 6E is a high-level logic flowchart of a process depicting alternate implementations of a transmitting at least one of the one or more subtasks operation 404 of FIG. 4.

FIG. 7A is a high-level logic flowchart of a process depicting alternate implementations of a receiving result data operation 406 of FIG. 4.

FIG. 7B is a high-level logic flowchart of a process depicting alternate implementations of a receiving result data operation 406 of FIG. 4.

FIG. 7C is a high-level logic flowchart of a process depicting alternate implementations of a receiving result data operation 406 of FIG. 4.

FIG. 7D is a high-level logic flowchart of a process depicting alternate implementations of a receiving result data operation 406 of FIG. 4.

FIG. 7E is a high-level logic flowchart of a process depicting alternate implementations of a receiving result data operation 406 of FIG. 4.

FIG. 7F is a high-level logic flowchart of a process depicting alternate implementations of a receiving result data operation 406 of FIG. 4.

FIG. 7G is a high-level logic flowchart of a process depicting alternate implementations of a receiving result data operation 406 of FIG. 4.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

In addition, the promulgation of portable electronic devices, each having their own set of unique sensors and detectors, has been widespread. Currently, there are very few populated areas of developed countries that do not contain a large number of portable computing devices at any given time. These portable computing devices are constantly collecting data, and capable of collecting data, which is not stored in any repository or transmitted to any device that may use such data. Thus, such data, and opportunity to collect data, may be lost.

In accordance with various embodiments, computationally implemented methods, systems, and articles of manufacture are provided for acquiring one or more subtasks that correspond to portions of a task of acquiring data requested by a task requestor, wherein the task of acquiring data is configured to be carried out by two or more discrete interface devices, transmitting at least one of the one or more subtasks to at least two of the two or more discrete interface devices, wherein the one or more subtasks are configured to be carried out in an absence of information regarding the task requestor and/or the task of acquiring data, and receiving result data corresponding to a result of an executed one or more subtasks. In various embodiments, such computationally implemented methods, systems, and articles of manufacture may be implemented at the interface device.

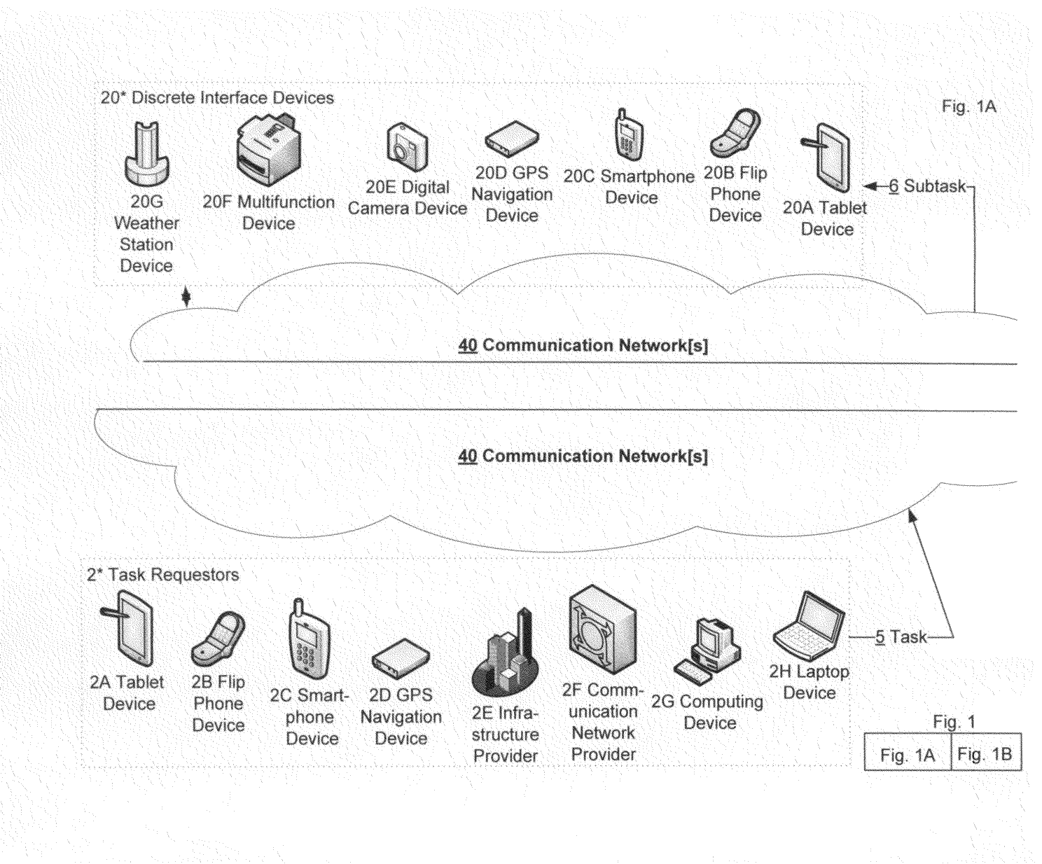

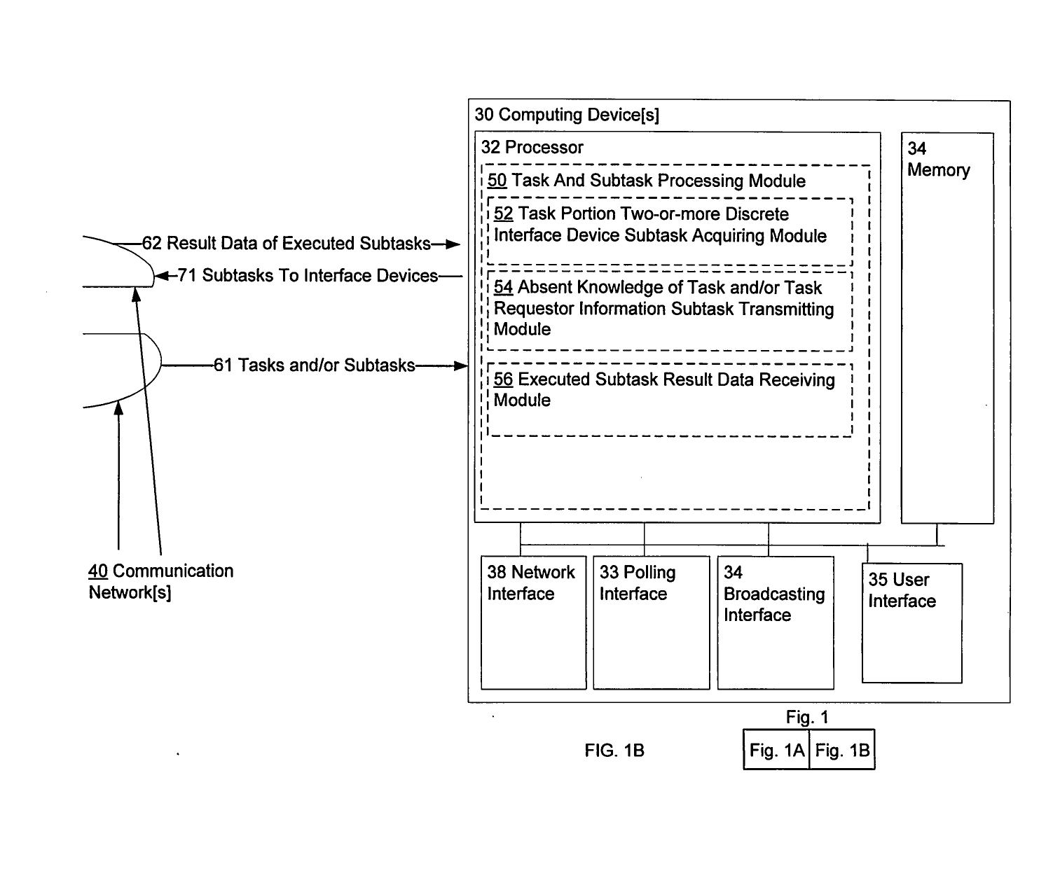

Referring now to FIG. 1, FIG. 1 illustrates a computing device 30 in an exemplary environment 100. As will be described in more detail herein, the computing device 30 may employ the computationally implemented methods, systems, and articles of manufacture in accordance with various embodiments. The computing device 30, in various embodiments, may be endowed with logic that is designed to acquire one or more subtasks that correspond to portions of a task of acquiring data requested by a task requestor, wherein the task of acquiring data is configured to be carried out by two or more discrete interface devices, transmit at least one of the one or more subtasks to at least two of the two or more discrete interface devices, wherein the one or more subtasks are configured to be carried out in an absence of information regarding the task requestor and/or the task of acquiring data, and receive result data corresponding to a result of an executed one or more subtasks

Note that in the following description, the character “*” represents a wildcard. Thus, references to, for example, task requestors 2* of FIG. 1 may be in reference to tablet device 2A, flip phone device 2B, smartphone device 2C, GPS navigation device 2D, infrastructure provider 2E, communication network provider 2F, computing device 2G, laptop device 2H, which may be part of computing device 30, but for the purposes of the interface devices described herein, is not distinguishable from the other task requestors 2*. FIG. 1 illustrates a number of task requestors 2*. For example, FIG. 1 illustrates task requestor 2A as a tablet, task requestor 2B as a flip phone, and task requestor 2C as a smartphone device. These drawings are meant to be illustrative only, and should not be construed as limiting the definition of task requestors 2*, which can be any device with computing functionality.

Similarly, interface devices 20* of FIG. 1 may be in reference to tablet device 20A, flip phone device 20B, smartphone device 20C, GPS navigation device 20D, digital camera device 20E, multifunction device 20F, and weather station device 20G. These drawings are meant to be illustrative only, and should not be construed as limiting the definition of interface devices 20*, which can be any device with computing functionality.

Within the context of this application, “discrete interface device” is defined as an “interface device capable of operating or being operated independently of other discrete interface devices.” The discrete interface devices may be completely unaware of each other, and are not necessarily the same type. For example, discrete interface devices 20*, which will be described in more detail herein, include but are not limited to laptop computers, computer tablets, digital music players, personal navigation systems, net books, smart phones, PDAs, digital still cameras, digital video cameras, vehicle assistance systems, and handheld game devices. For the purposes of this application, the type of interface device is not important, except that it can communicate with a communications network, and that it has device characteristics and status, as will be described in more detail herein.

Referring again to the exemplary environment 100 of FIG. 1, in various embodiments, the task requestors 2 may send a task, e.g., task 5 to computing device 30. Computing device 30 may be any type of device that has a processor and may communicate with other devices. Although FIG. 1 illustrates computing device 30 as a single unit, computing device 30 may be implemented as multiple computers, servers, or other devices, operating singularly or in parallel, connected locally or via any type of network. As shown in FIG. 1, computing device 30 is illustrated as having several modules that will be discussed in more detail herein. Specifically, these particular modules may be implemented across different networks and systems, and may be partially or wholly unaware of each other, except for the need to transmit data as indicated by the arrows within computing device 30.

A task 5 sent from a task requestor 2* may be received by computing device 30, and separated into its component subtasks. In other embodiments, a task 5 sent from a task requestor 2* may be received by another computing device (not shown), and separated into its component subtasks, which then may be sent to computing device 30. In some embodiments, the another computing device may rely on partial human intervention to be separated into its component subtasks. In other embodiments, the another computing device may be entirely automated, and may use such techniques as are known in the art to separate tasks into subtasks. Tasks may be separated into component subtasks using any known type of processing, including neural net processing, natural language processing, machine learning, logic-based processing, and knowledge-based processing. For example, a received task may be “Take a 360 degree picture of the Eiffel Tower.” The subtask acquiring module 32 may process the language of this received task, and separate it into components of “take a picture of the Eiffel Tower.” Either by consulting machine archives or by predicting how many pictures must be combined to make a 360 degree picture, the system may determine, for example, that 25 pictures of the Eiffel Tower are needed. These twenty-five “take a picture of the Eiffel Tower” subtasks thus are created. The preceding example is merely a simple example of how a computing device 30 may process tasks into subtasks. Other methods, which may be substantially more complex, may be used in this process, but are not discussed in detail here.

The computing device 30 may communicate via a communications network 40. In various embodiments, the communication network 40 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 40 may be wired, wireless, or a combination of wired and wireless networks. It is noted that “communication network” here refers to communication networks, which may or may not interact with each other. It is further noted, that, in this drawing, communication network 40 is shown having a split between the task requestors 2* and the discrete interface devices 20*. This is because, in embodiments, the discrete interface devices 20* cannot communicate with the task requestors 2*. As will be discussed in more detail herein, the discrete interface devices 20* operate with a smaller subset of information than what is available to task requestors 2* regarding the nature of the task and/or the task requestor, e.g., discrete interface devices 20* operate in an “absence of information regarding the task and/or the task requestor.”

Computing device 30 may include a network interface module 38 to facilitate communications with communications network 40. Network interface module 38, which may be implemented as hardware or software, or both, used to interface the computing device 30 with the one or more communication networks 40. In some embodiments, the network interface module 38 may be a Network Interface Card, e.g., a NIC, or an antenna. The specific structure of network interface module 38 depends on the type or types of one or more communication networks 40 that are used. Particular details of this transmission will be discussed in more detail herein.

Computing device 30 also may include a polling interface 33 and a broadcasting interface 34, which also may interface with communications network 40. Polling interface 33 and broadcasting interface 34 also may be implemented as hardware or software, or both, and may share component parts and/or machine-readable instructions with network interface module 38. In some embodiments, the same hardware and/or software is used to implement network interface 38, polling interface 33, and broadcasting interface 34. The specific functions of these devices will be discussed in more detail herein with respect to the modules and computationally-implemented methods described herein.

As shown in FIG. 1, computing device 30 may receive tasks and/or subtasks 61 from the communication network, either directly from the task requestors 2* or from another computing device (not shown) that collects and/or processes the tasks received from task requestors 2*. Computing device 30 transmits subtasks to interface devices 71, in a process that will be described in more detail herein, and also receives result data of executed subtasks 62, in a process that will be described in more detail herein.

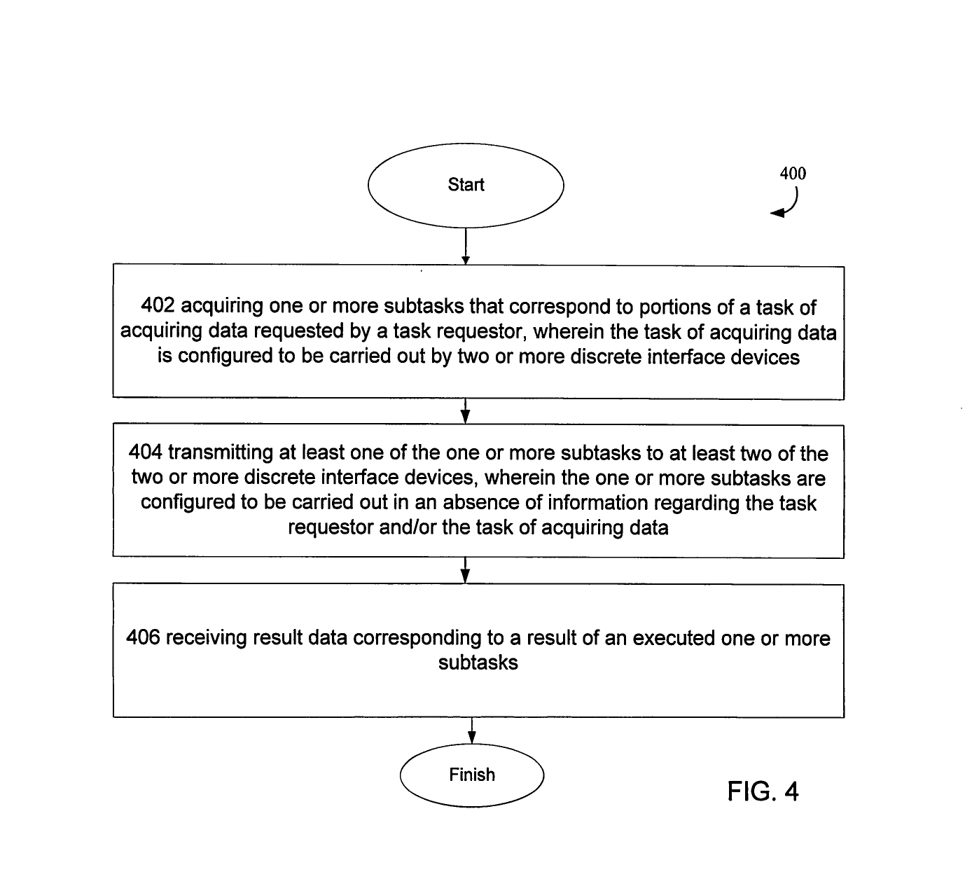

In some embodiments, the subtask data 71 is executed by the interface device 20* automatically to carry out the subtask. In some embodiments, the subtask data 71 may be instructions for displaying commands on a user interface of the interface device 20*, for a user to carry out to complete the subtask. It is noted that, in some embodiments, a “user” is a representation of a person operating an electronic device, e.g., a portable computing device, or a non-portable computing device, e.g., a desktop computer, an information kiosk, or a terminal, e.g., an ATM terminal. In other embodiments, however, a user is merely a representation of a machine or person making a request. For example, a user may be an automated program that carries out tasks. As will be further described with reference to FIG. 4, the operational flow 400 may be executed in a variety of different ways in various alternative implementations, which will be discussed in more detail herein.

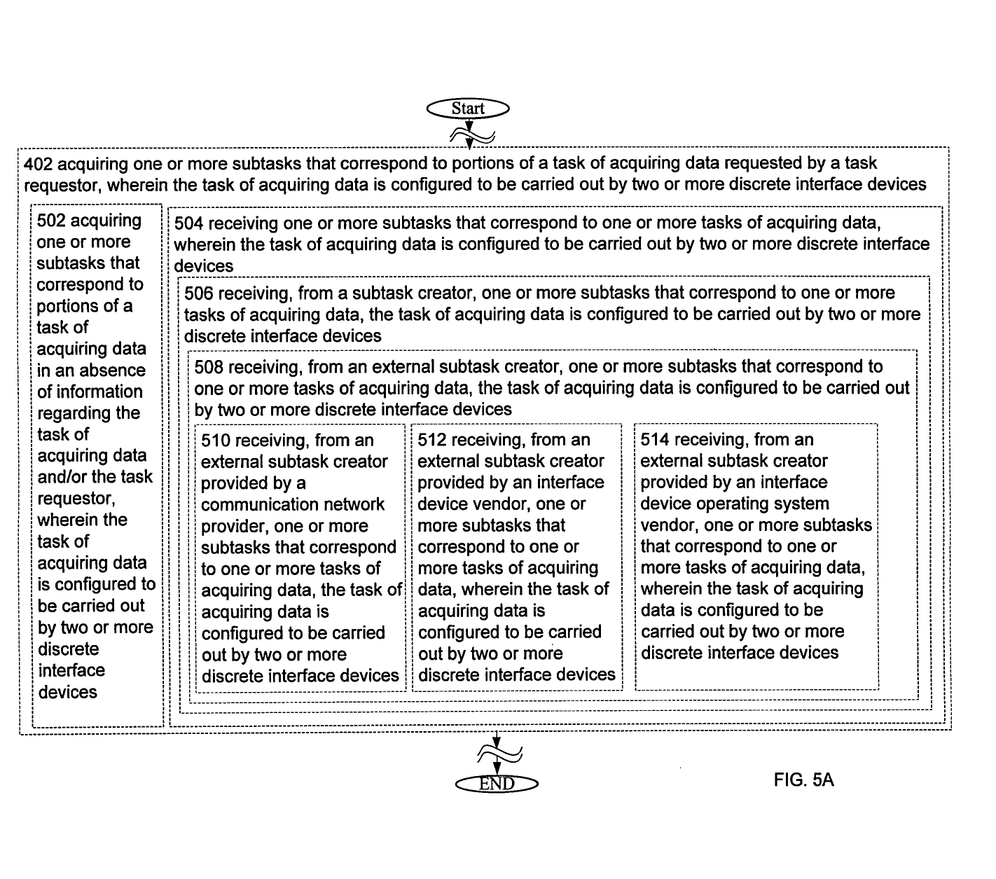

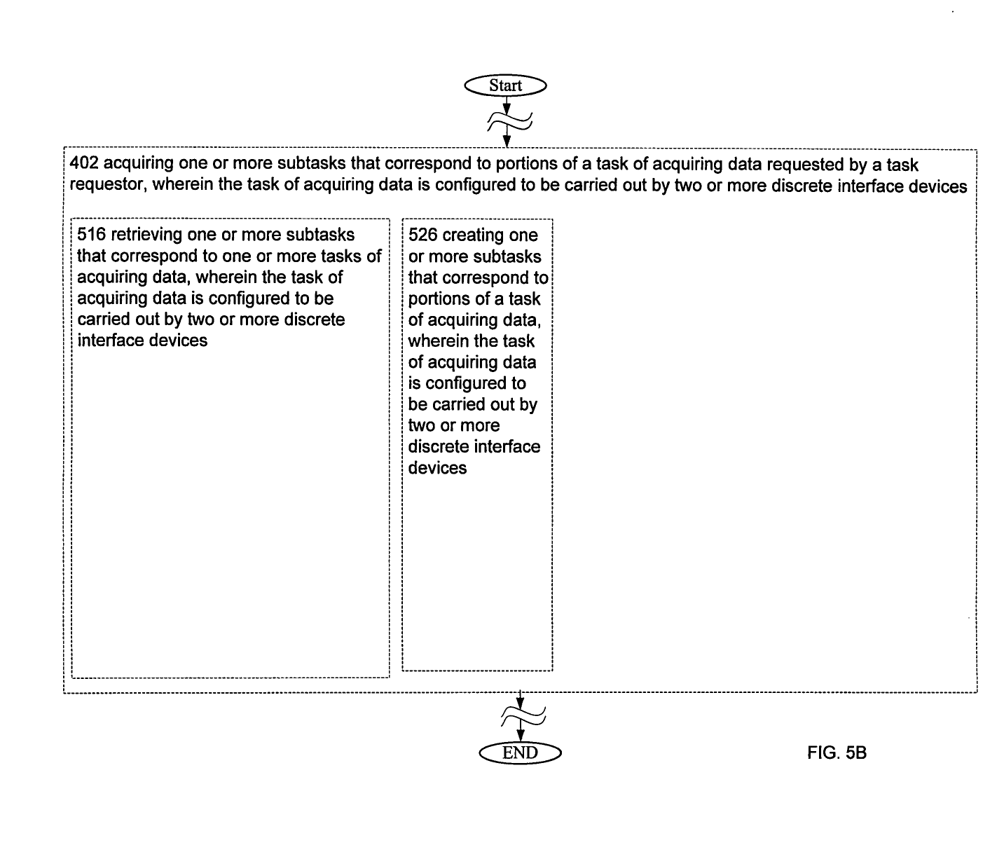

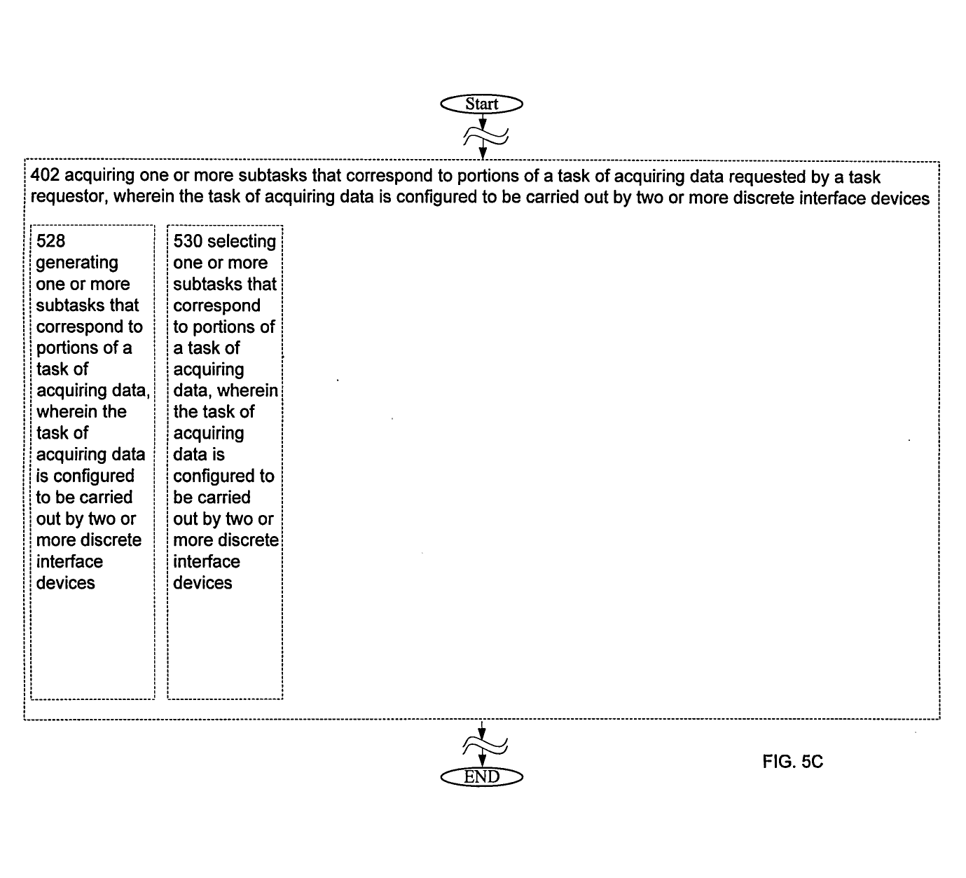

Referring again to the example environment 100 of FIG. 1, in various embodiments, the computing device 30 may comprise, among other elements, a processor 32, a memory 34, and a user interface 35. Processor 32 may include one or more microprocessors, Central Processing Units (“CPU”), a Graphics Processing Units (“GPU”), Physics Processing Units, Digital Signal Processors, Network Processors, Floating Point Processors, and the like. In some embodiments, processor 32 may be a server. In some embodiments, processor 32 may be a distributed-core processor. Although processor 32 is depicted as a single processor that is part of a single computing device 30, in some embodiments, processor 32 may be multiple processors distributed over one or many computing devices 30, which may or may not be configured to work together. Processor 32 is illustrated as being configured to execute computer readable instructions in order to execute one or more operations described above, and as illustrated in FIGS. 5A-5C, 6A-6E, and 7A-7G. In some embodiments, processor 32 is designed to be configured to operate as the subtask module 50, which may include task portion two-or-more discrete interface device subtask acquiring module 52, absent knowledge of task and/or task requestor information subtask transmitting module 54, and executed subtask result data receiving module 56.

As described above, the computing device 30 may comprise a memory 34. In some embodiments, memory 34 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 34 may be located at a single network site. In other embodiments, memory 34 may be located at multiple network sites, including sites that are distant from each other.

As described above, and with reference to FIG. 1, computing device 30 may include a user interface 35. The user interface may be implemented in hardware or software, or both, and may include various input and output devices to allow an operator of a computing device 30 to interact with computing device 30. For example, user interface 35 may include, but is not limited to, an audio display, a video display, a microphone, a camera, a keyboard, a mouse, a joystick, a game controller, a touchpad, a handset, or any other device that allows interaction between a computing device and a user.

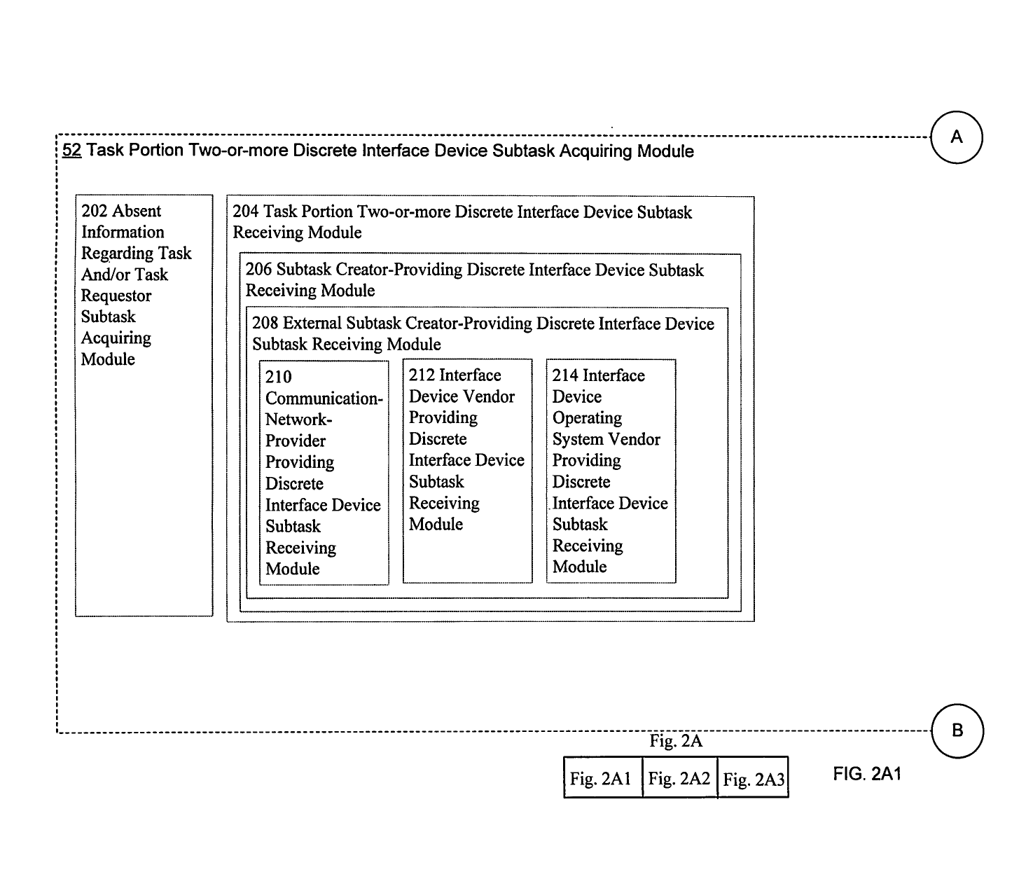

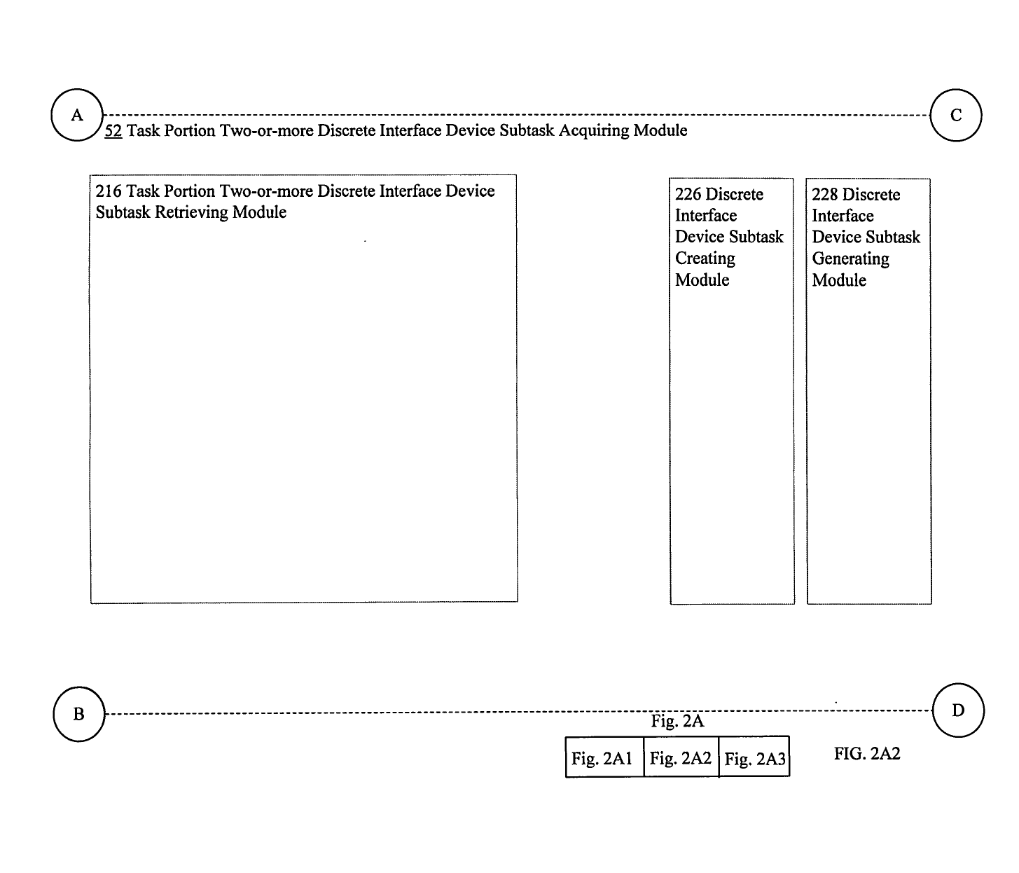

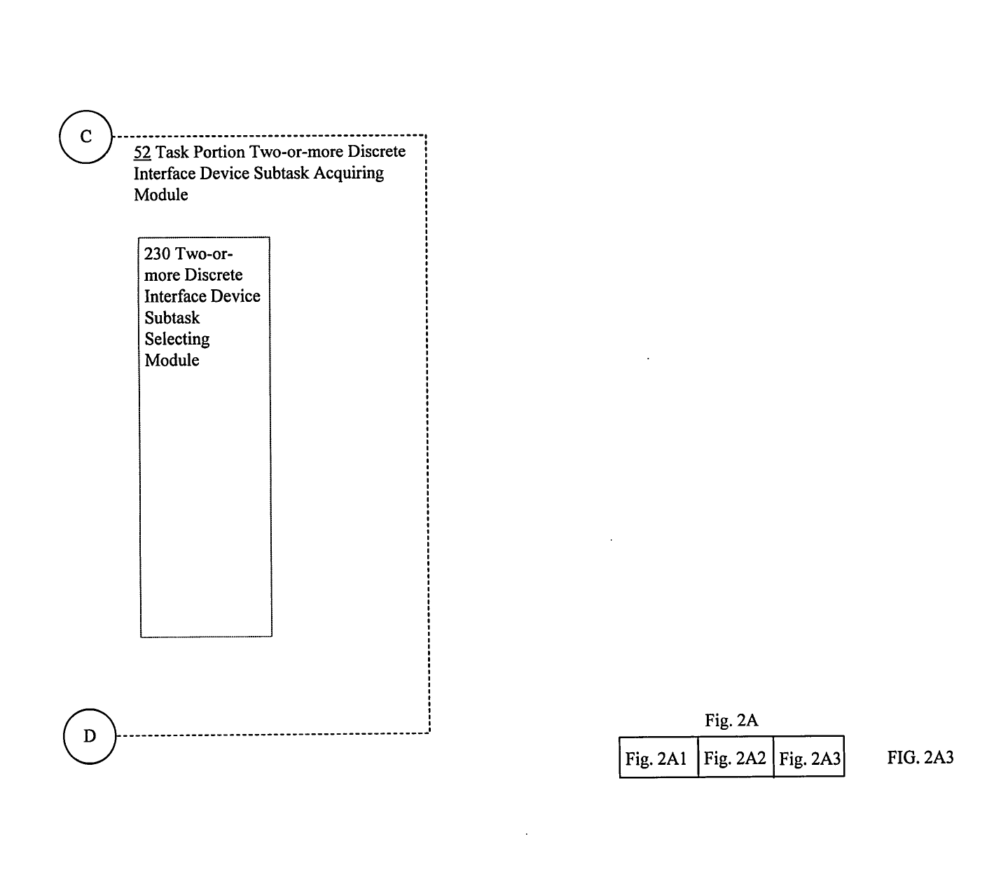

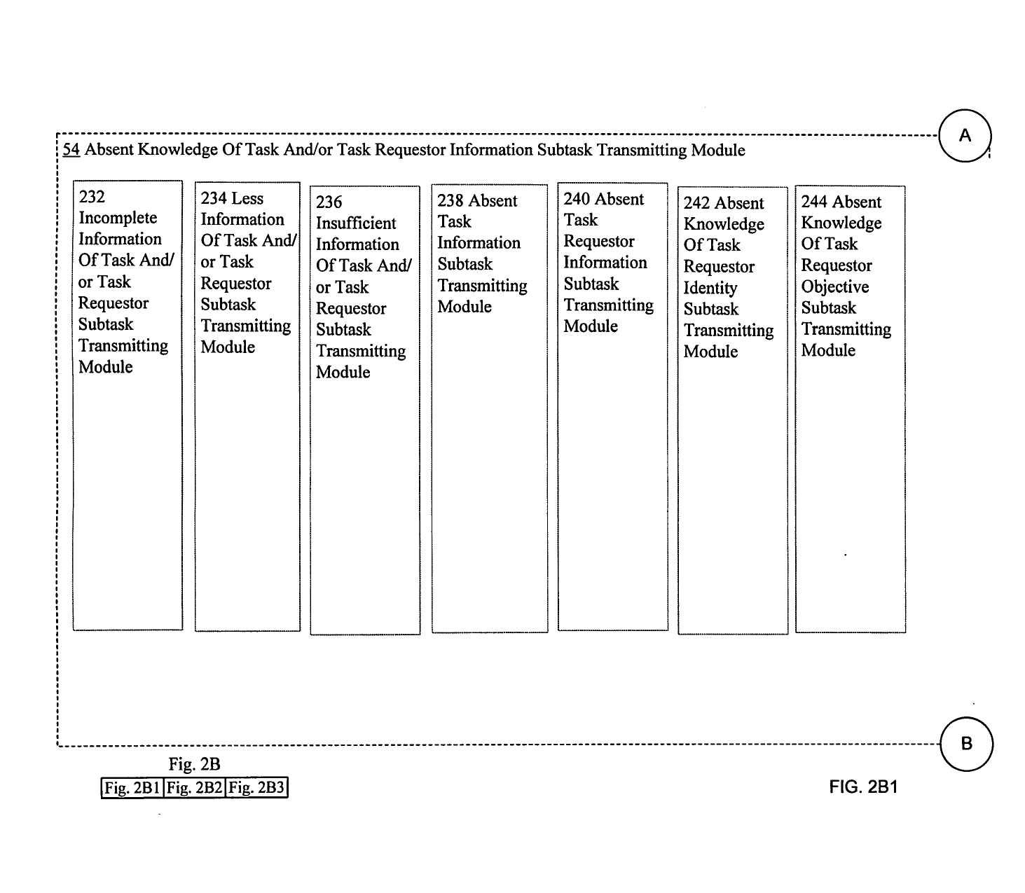

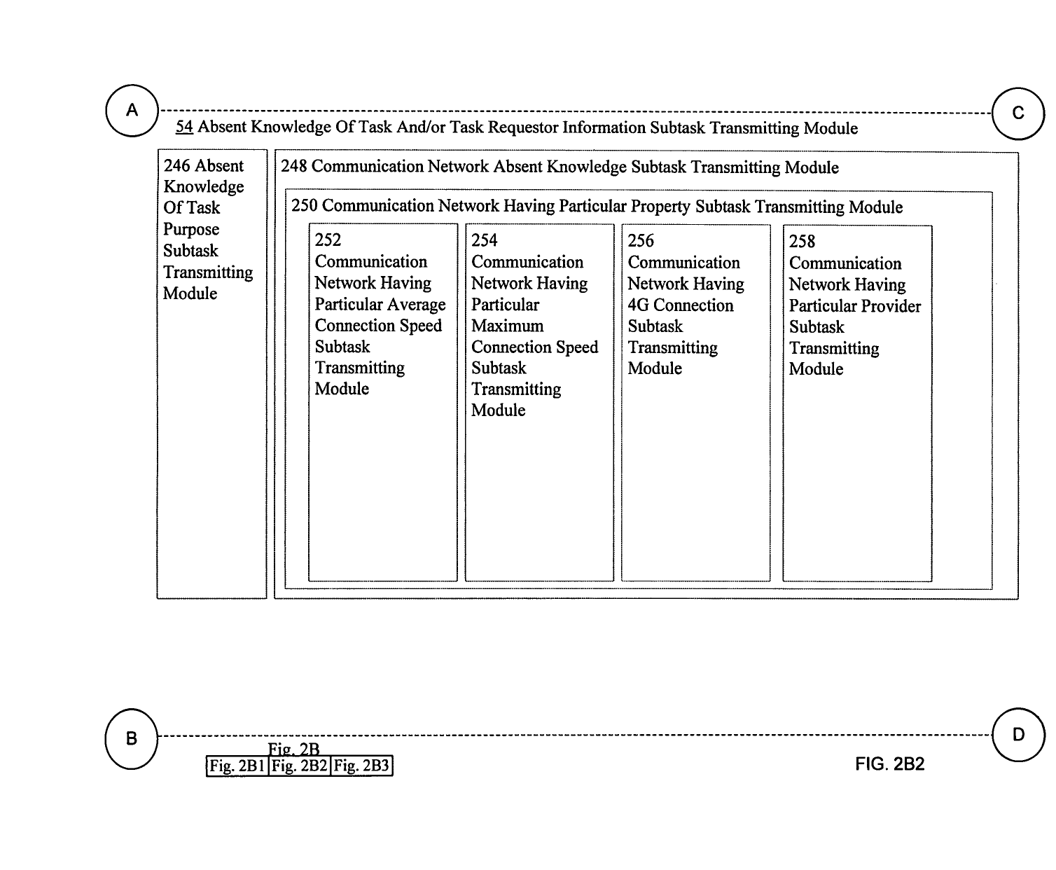

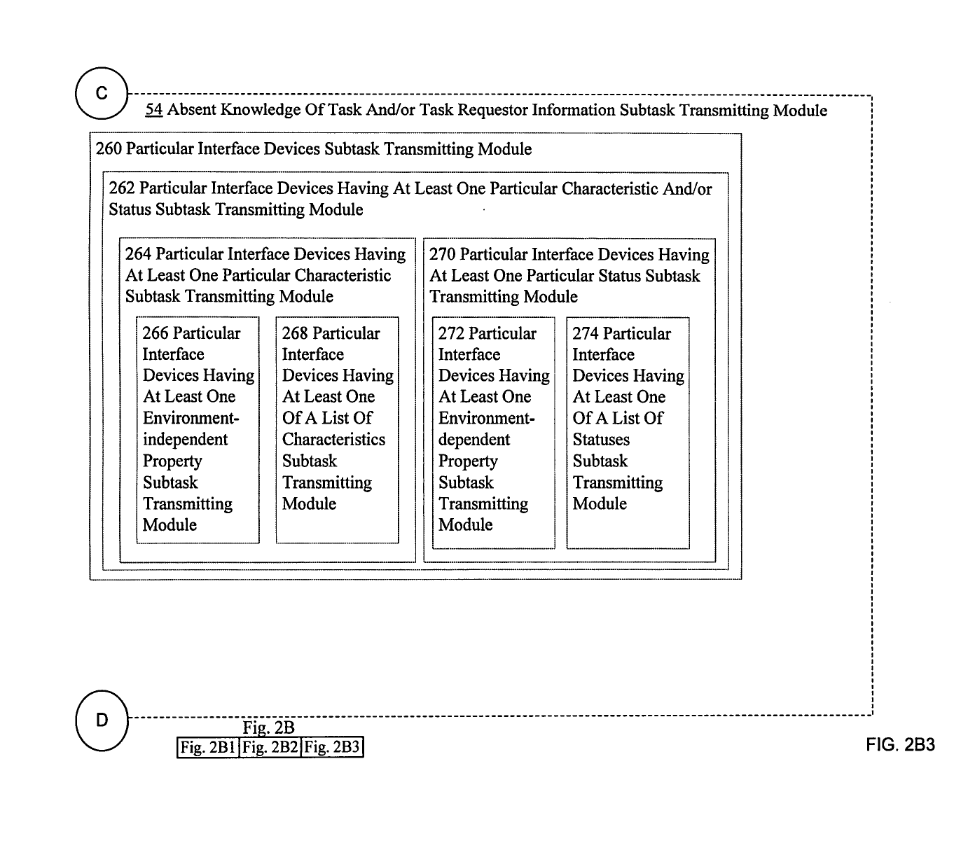

Referring now to FIG. 2A, FIG. 2A illustrates an exemplary implementation of the task portion two-or-more discrete interface device subtask acquiring module 52 of the subtask module 50. As illustrated in FIG. 2A, the task portion two-or-more discrete interface device subtask acquiring module 52 may include one or more sub-logic modules in various alternative implementations and embodiments. For example, in some embodiments, module 52 may include an absent information regarding task and/or task requestor subtask acquiring module 202 and a task portion two-or-more discrete interface device subtask receiving module 204. In some embodiments, module 204 may include a subtask creator-providing discrete interface device subtask receiving module 206 (e.g., which may, in some embodiments, include external subtask creator-providing discrete interface device subtask receiving module 208). In some embodiments, module 208 may include communication network-provider providing discrete interface device subtask receiving module 210, interface device vendor providing discrete interface device subtask receiving module 212, and interface device operating system vendor providing discrete interface device subtask receiving module 214.

In some embodiments, module 52 may include task portion two-or-more discrete interface device subtask retrieving module 217, discrete interface device subtask creating module 226, discrete interface device subtask generating module 228, and two-or-more discrete interface device subtask selecting module 230.

Referring now to FIG. 2B, FIG. 2B illustrates an exemplary implementation of the absent knowledge of task and/or task requestor information subtask transmitting module 54 of the subtask module 50. As illustrated in FIG. 2B, the module 54 may include incomplete information of task and/or task requestor subtask transmitting module 232, less information of task and/or task requestor subtask transmitting module 234, insufficient information of task and/or task requestor subtask transmitting module 236, absent task information subtask transmitting module 238, absent task requestor information subtask transmitting module 240, absent knowledge of task requestor identity subtask transmitting module 242, and absent knowledge of task requestor objective subtask transmitting module 244.

In some embodiments, module 54 may include absent knowledge of task purpose subtask transmitting module 246, and communication network absent knowledge subtask transmitting module 248. In some embodiments, module 248 may include communication network having particular property subtask transmitting module 250 (e.g., which, in some embodiments, may include communication network having particular average connection speed subtask transmitting module 252, communication network having particular maximum connection speed subtask transmitting module 254, communication network having $G connection subtask transmitting module 256, and communication network having particular provider subtask transmitting module 258.

In some embodiments, module 54 may include particular interface devices subtask transmitting module 260. In some embodiments, module 260 may include particular interface devices having at least one particular characteristic and/or status subtask transmitting module 262. In some embodiments, module 262 may include particular interface devices having at least one particular characteristic subtask transmitting module 264 (e.g., which, in some embodiments, may include particular interface devices having at least one environment-independent property subtask transmitting module 266 and particular interface devices having at least one of a list of characteristics subtask transmitting module 268) and particular interface devices having at least one particular status subtask transmitting module 264 (e.g., which, in some embodiments, may include particular interface devices having at least one environment-dependent property subtask transmitting module 266 and particular interface devices having at least one of a list of statuses subtask transmitting module 268).

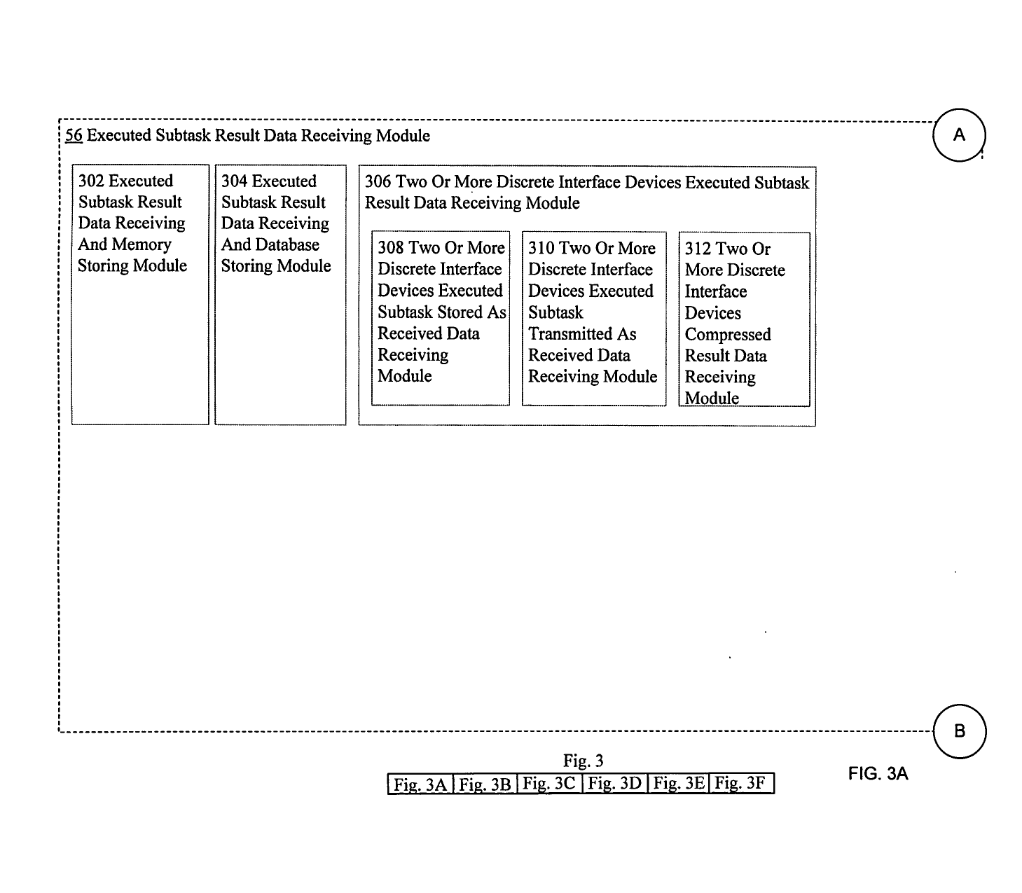

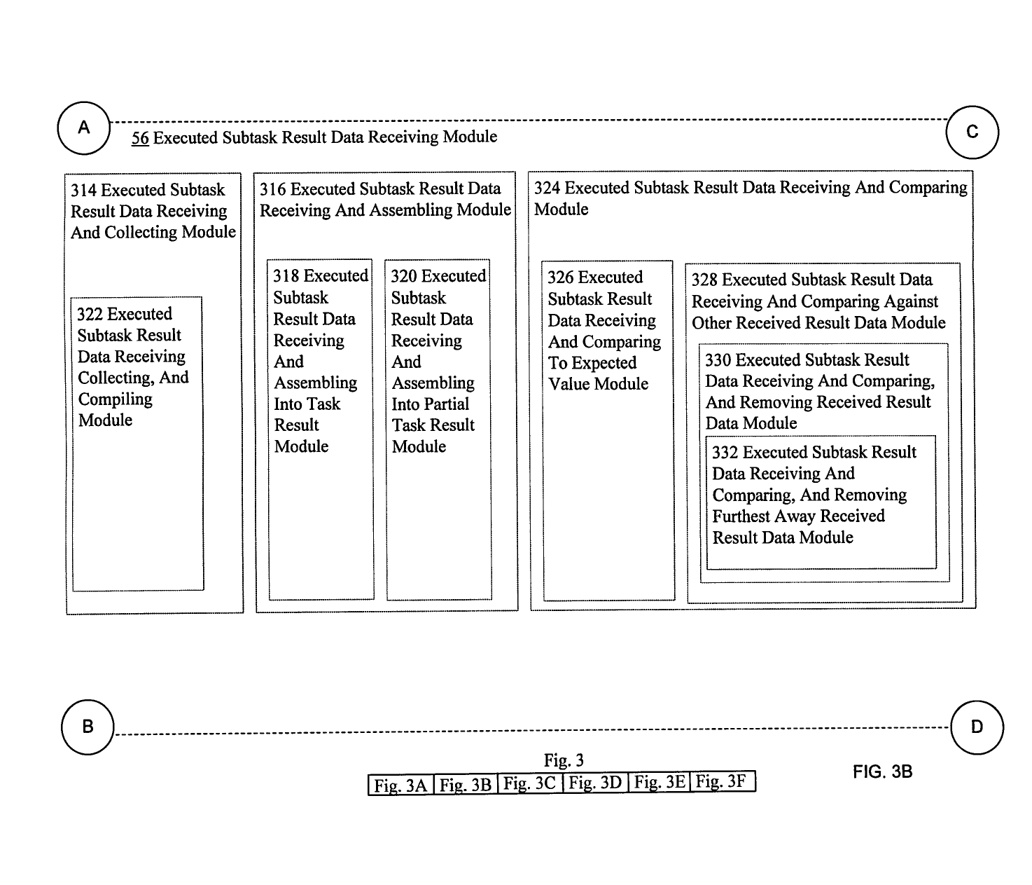

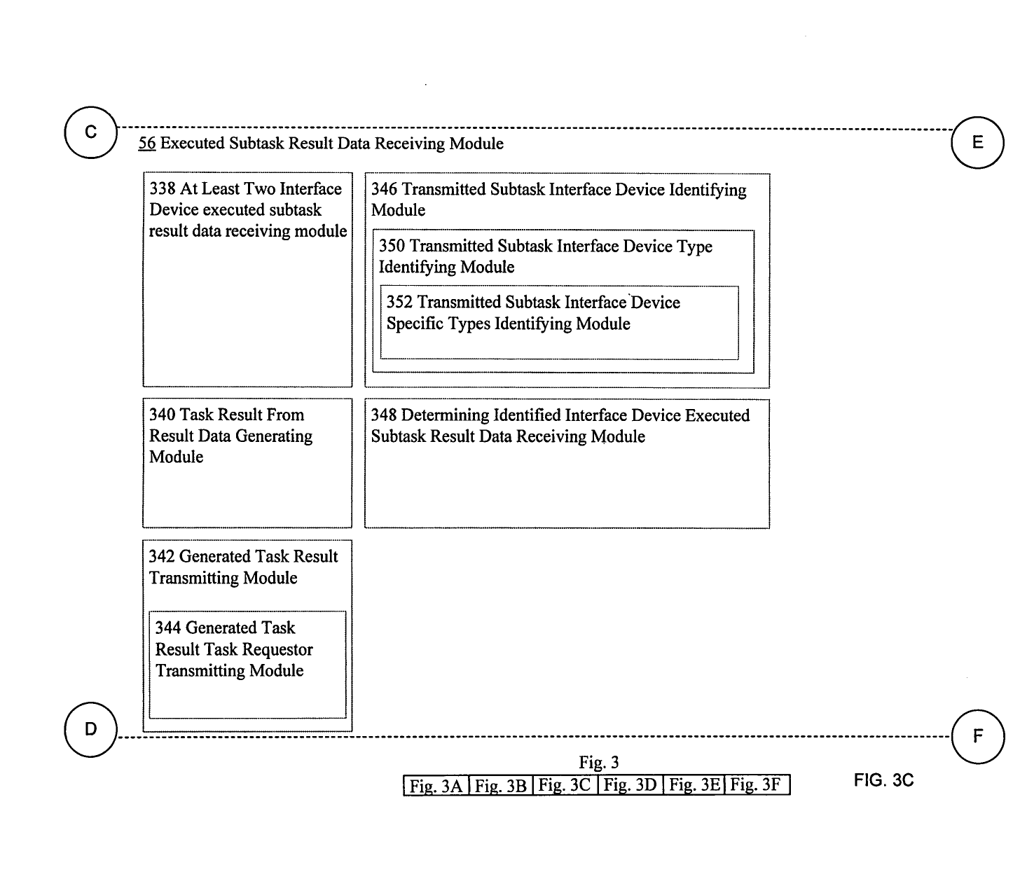

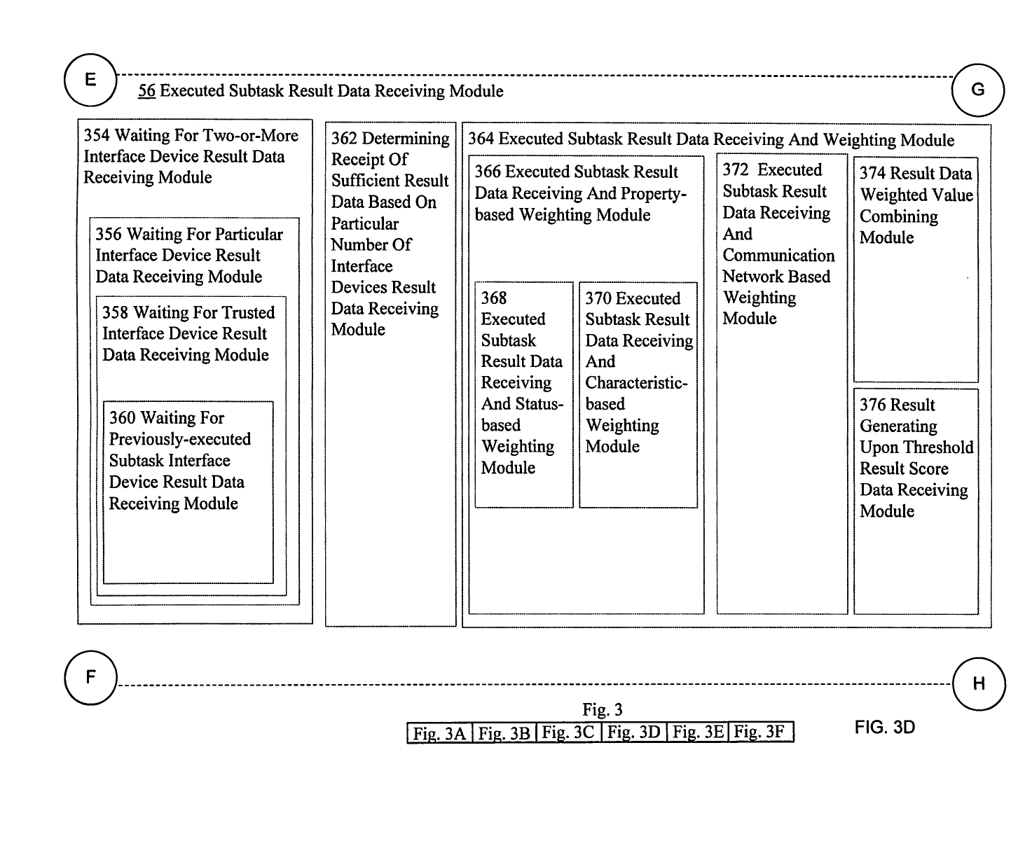

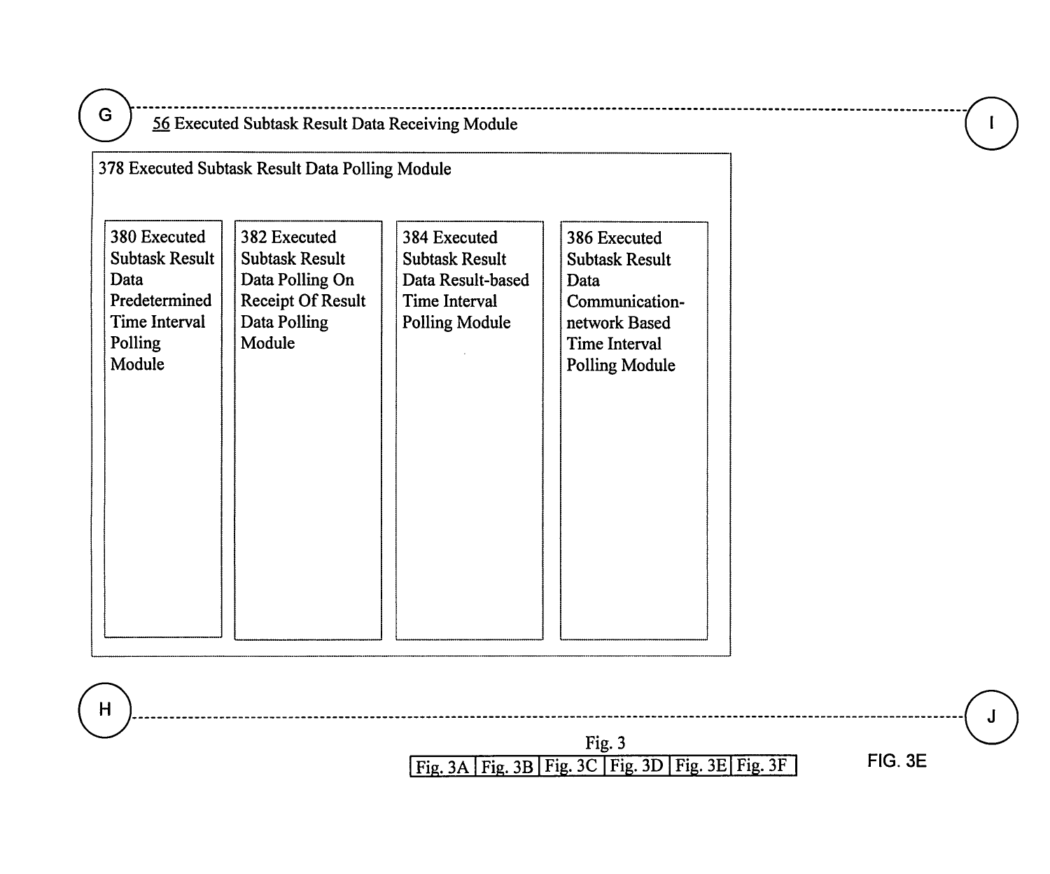

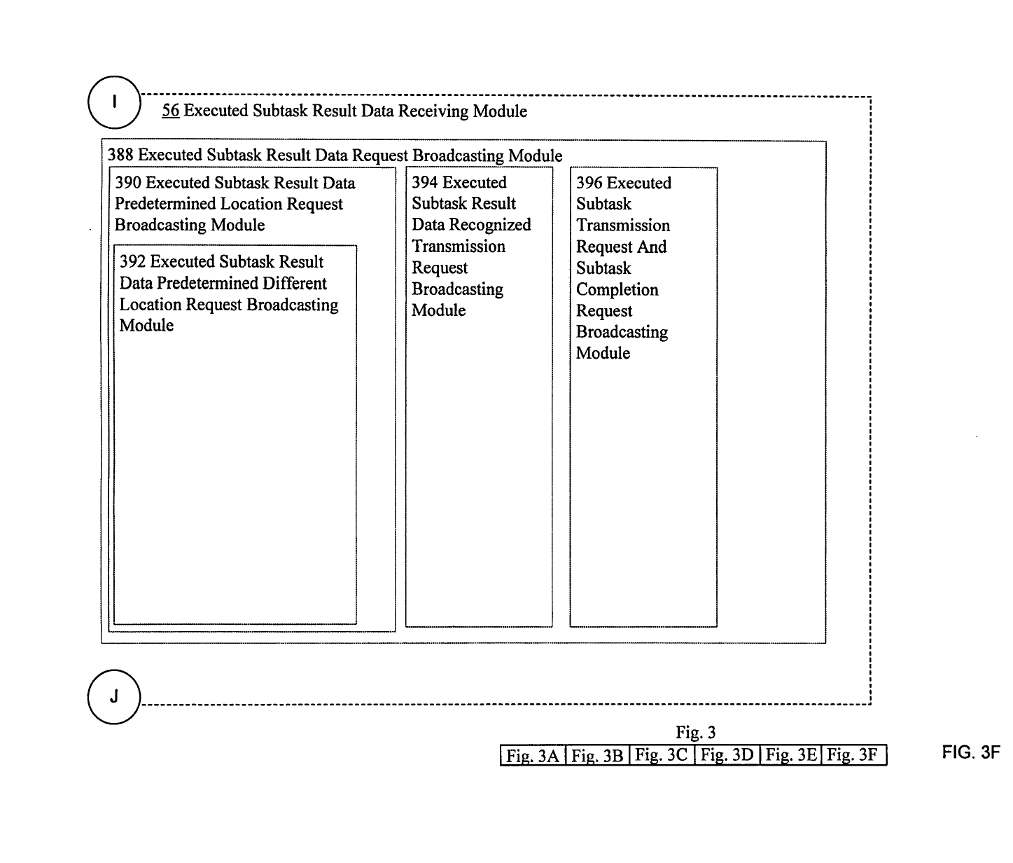

Referring now to FIG. 3, FIG. 3 illustrates an exemplary implementation of the executed subtask result data receiving module 56 of the subtask module 50. As illustrated in FIG. 3, module 56 may include executed subtask result data receiving and memory storing module 302, executed subtask result data receiving and database storing module 304, two or more discrete interface devices executed subtask result data receiving module 306 (e.g., which, in some embodiments, may include two or more discrete interface devices executed subtask stored as received data receiving module, two or more discrete interface devices executed subtask transmitted as received data receiving module, and two or more discrete interface devices compressed result data receiving module 312).

In some embodiments, module 56 may include executed subtask result data receiving and collecting module 314 (e.g., which, in some embodiments, may include executed subtask result data receiving, collecting, and compiling module 322), executed subtask result data receiving and assembling module 316 (e.g., which, in some embodiments, may include executed subtask result data receiving and assembling into task result module 318, and executed subtask result data receiving and assembling into partial task result module 320), and executed subtask result data receiving and comparing module 324. In some embodiments, module 324 may include executed subtask result data receiving and comparing to expected value module 326 and executed subtask result data receiving and comparing against other received result data module 328. In some embodiments, module 328 may include executed subtask result data receiving and comparing, and removing received result data module (e.g., which, in some embodiments, may include executed subtask result data receiving and comparing, and removing furthest away received result data module.

In some embodiments, module 56 may include at least two interface device executed subtask result data receiving module 338, task result from result data generating module 340, and generated task result transmitting module 342 (e.g., which, in some embodiments, may include generated task result task requestor transmitting module 344). In some embodiments, module 56 may include transmitted subtask interface device identifying module 346 and determined identified interface device executed subtask result data receiving module 348. In some embodiments, module 346 may include transmitted subtask interface device type identifying module 350 (e.g., which, in some embodiments, may include transmitted subtask interface device specific types identifying module.

In some embodiments, module 356 may include waiting for two-or-more interface device result data receiving module 354 (e.g., which may include waiting for particular interface device result data receiving module 356 (e.g., which may include waiting for trusted interface device result data receiving module 358 (e.g., which may include waiting for previously-executed subtask interface device result data receiving module 360))), determining receipt of sufficient result data based on particular number of interface devices result data receiving module 362, and executed subtask result data receiving and weighting module 364. Module 364 may include executed subtask result data receiving and property-based weighting module 366 (e.g., which, in some embodiments, may include executed subtask result data receiving and status-based weighting module 368 and executed subtask result data receiving and characteristic-based weighting module 370), executed subtask result data receiving and communication network based weighting module 372, result data weighted value combining module 374, and result generating upon threshold result score data receiving module 376.

In some embodiments, module 56 may include executed subtask result data polling module 378. In some embodiments, module 378 may include executed subtask result data predetermined time interval polling module 380, executed subtask result data polling on receipt of result data polling module 382, executed subtask result data result-based time interval polling module 384, and executed subtask result data communication network based time interval polling module 386.

In some embodiments, module 56 may include execute subtask result data request broadcasting module 388. In some embodiments, module 388 may include executed subtask result data predetermined location request broadcasting module 390 (e.g., which, in some embodiments, may include executed subtask result data predetermined different location request broadcasting module 392), executed subtask result data recognized transmission request broadcasting module 394, and executed subtask transmission request and subtask completion request broadcasting module 396.

A more detailed discussion related to computing device 30 of FIG. 1 now will be provided with respect to the processes and operations to be described herein. Referring now to FIG. 4, FIG. 4 illustrates an operational flow 400 representing example operations for, among other methods, acquiring one or more subtasks that correspond to portions of a task of acquiring data requested by a task requestor, wherein the task of acquiring data is configured to be carried out by two or more discrete interface devices, transmitting at least one of the one or more subtasks to at least two of the two or more discrete interface devices, wherein the one or more subtasks are configured to be carried out in an absence of information regarding the task requestor and/or the task of acquiring data, and receiving result data corresponding to a result of an executed one or more subtasks. In FIG. 4 and in the following figures that include various examples of operational flows, discussions and explanations will be provided with respect to the exemplary environment 100 as described above and as illustrated in FIG. 1, and with respect to other examples (e.g., as provided in FIGS. 2A, 2B, and 3) and contexts. It should be understood that the operational flows may be executed in a number of other environments and contexts, and/or in modified versions of the systems shown in FIGS. 2A, 2B, and 3. Although the various operational flows are presented in the sequence(s) illustrated, it should be understood that the various operations may be performed in other orders other than those which are illustrated, or may be performed concurrently.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 4 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 4 as well as the other operations to be described herein may be performed by at least one of a machine, an article of manufacture, or a composition of matter.

It is noted that, for the examples set forth in this application, the tasks and subtasks are commonly represented by short strings of text. This representation is merely for ease of explanation and illustration, and should not be considered as defining the format of tasks and subtasks. Rather, in various embodiments, the tasks and subtasks may be stored and represented in any data format or structure, including numbers, strings, Booleans, classes, methods, complex data structures, and the like.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Referring again to FIG. 4, FIG. 4 shows operation 400 that includes operation 402 depicting acquiring one or more subtasks that correspond to portions of a task of acquiring data requested by a task requestor, wherein the task of acquiring data is configured to be carried out by two or more discrete interface devices. For example, referring to FIG. 1, FIG. 1 shows task portion two-or-more discrete interface subtask acquiring module 52 acquiring one or more subtasks (e.g., “take a picture of the Eiffel Tower from your location”) that correspond to portions of a task (e.g. “take a 360-degree picture of the Eiffel Tower at night”) requested by a task requestor (e.g., a person using a smartphone in Centerville, Ohio, requests a 360-degree picture of the Eiffel Tower for a grade school science project), wherein the task of acquiring data (e.g., the 360-degree image data of the location) is configured to be carried out by two or more discrete interface devices (e.g., two or more cellular phones, smartphones, network-connected cameras will provide image data to carry out the task of acquiring data).

Referring again to FIG. 4, operation 400 includes operation 404 depicting transmitting at least one of the one or more subtasks to at least two of the two or more discrete interface devices, wherein the one or more subtasks are configured to be carried out in an absence of information regarding the task requestor and/or the task of acquiring data. For example, referring to FIG. 1, FIG. 1 shows absent knowledge of task and/or task requestor information subtask transmitting module 54 transmitting at least one of the one or more subtasks (e.g., “take a picture of the Eiffel Tower from your location”) to at least two of the two or more discrete interface devices (e.g., an iPhone 5 and a Samsung SH100 WiFi camera), wherein the one or more subtasks (e.g., “take a picture of the Eiffel Tower”) are configured to be carried out in an absence of information regarding the task requestor (e.g., the iPhone 5 and the Samsung SH100 do not know the identity of the task requestor) and/or the task of acquiring data (e.g., the iPhone 5 and the Samsung SH100 do not know what the task of acquiring data is, only that they are to take a picture of the Eiffel Tower).

It is noted that “in an absence of information” does not imply a complete absence of information, but rather that the interface devices carrying out the subtasks have a smaller subset of information than a single device carrying out the task of acquiring data would have. In some instances, a sufficiently advanced interface device could infer the task of acquiring data, or guess the task of acquiring data, but the interface device would still be operating in an “absence of information” as defined in the claims. It is not necessary for the interface device to operate in a complete lack of information regarding the task and/or the task requestor to operate in an absence of information. Some exemplary “absence of information” scenarios will be discussed in more detail herein. These examples are not intended to be exhaustive but rather to illustrate examples of scenarios that present an “absence of information.”

Referring again to FIG. 4, operation 400 further includes operation 406 depicting receiving result data corresponding to a result of an executed one or more subtasks. For example, referring to FIG. 1, FIG. 1 shows executed subtask result receiving data module 56 receiving result data (e.g., the image data of the picture taken by the iPhone 5 and the Samsung SH100) corresponding to a result (e.g., the taken picture) of an executed one or more subtasks (e.g., “take a picture of the Eiffel Tower from your location”).

FIGS. 5A-5C depict various implementations of operation 402, according to embodiments. Referring now to FIG. 5A, operation 402 may include operation 502 depicting acquiring one or more subtasks that correspond to portions of a task of acquiring data in an absence of information regarding the task of acquiring data and/or the task requestor, wherein the task of acquiring data is configured to be carried out by two or more discrete interface devices. For example, referring to FIG. 2A, FIG. 2A shows absent information regarding task and/or task requestor subtask acquiring module 202 acquiring one or more subtasks (e.g., “query a user at a particular location regarding how long the wait is at Dunkin' Donuts”) that correspond to portions of a task of acquiring data (e.g., “determine the fastest place to get a cup of coffee in Old Town Alexandria”) in an absence of information regarding the task of acquiring data (e.g., the user and the interface device do not know what the task is) and/or the task requestor (e.g., the step of transmitting the subtask of “query a user at a particular location regarding how long the wait is at Dunkin Donuts” is carried out by an entity do not know who requested the task, or what type of entity requested the task, e.g., a person looking for coffee, the Alexandria city planning committee, Dunkin Donuts corporate people), wherein the task of acquiring data is configured to be carried out by two or more discrete interface devices (e.g., an iPhone of a person standing in a Dunkin Donuts on King Street, and a Blackberry of a person standing in a Dunkin Donuts on Eisenhower Avenue near the Metro).

Referring again to FIG. 5A, operation 402 may include operation 504 depicting receiving one or more subtasks that correspond to one or more tasks of acquiring data, wherein the task of acquiring data is configured to be carried out by two or more discrete interface devices. For example, referring to FIG. 2A, FIG. 2A shows task portion two-or-more discrete interface device subtask receiving module 204 receiving (e.g., an external subtask sending server sends a list of subtasks, including “take an image of the interior of the Starbucks Coffee at your location”) one or more subtasks (e.g., “take an image of the interior of the Starbucks Coffee at your location” that correspond to one or more tasks of acquiring data (e.g., “determine the number of people inside a Starbucks Coffee by capturing multiple images of the interior of the store and performing image analysis”), wherein the task of acquiring data is configured to be carried out by two or more discrete interface devices.

Referring again to FIG. 5A, operation 504 may further include operation 506 depicting receiving, from a subtask creator, one or more subtasks that correspond to one or more tasks of acquiring data, wherein the task of acquiring data is configured to be carried out by two or more discrete interface devices. For example, FIG. 2A shows subtask creator-providing discrete interface device subtask receiving module 206 receiving, (e.g., transmitted over wires or a network), from a subtask creator (e.g., an subtask creating service, e.g., an adaptive computer configured to break down tasks into subtasks, which may be an integrated part of the system transmitting the subtasks), one or more subtasks (e.g., “determine a wireless network strength at your location”) that correspond to one or more tasks of acquiring data (e.g., “determine which area of Washington D.C. has the best network signal strength”), the task of acquiring data is configured to be carried out by two or more discrete interface devices (e.g., the task of “determine which area of Washington D.C. has the best network signal strength” is carried out by a set of iPhone 5s on K Street, and a set of Samsung Galaxy IIs in Adams Morgan, as well as others).

Referring again to FIG. 5A, operation 506 may further include operation 508 depicting receiving, from an external subtask creator, one or more subtasks that correspond to one or more tasks of acquiring data, wherein the task of acquiring data is configured to be carried out by two or more discrete interface devices. For example, FIG. 2A shows external subtask creator-providing discrete interface device subtask receiving module 208 receiving, from an external subtask creator (e.g., an external subtask creating service contracted out to create subtasks from tasks and transmit them to subtask distributors), one or more subtasks (e.g., “determine a number of wireless networks at your location”) that correspond to one or more tasks of acquiring data (e.g., “determine which area of Washington DC has the greatest number of wireless networks per square block”), wherein the task of acquiring data is configured to be carried out by two or more discrete interface devices (e.g., the task of “determine which area of Washington D.C. has the greatest number of wireless networks per square block” may be determined by a set of iPads in Foggy Bottom, and an ASUS EeePc in Logan Circle).

Referring again to FIG. 5A, operation 508 may further include operation 510 depicting receiving, from an external subtask creator provided by a communication network provider, one or more subtasks that correspond to one or more tasks of acquiring data, wherein the task of acquiring data is configured to be carried out by two or more discrete interface devices. For example, FIG. 2A shows communication-network-provider providing discrete interface device subtask receiving module 210 receiving, from an external subtask creator provided by a communication network provider (e.g., AT&T receives tasks from customers, or generates tasks that will help it analyze its business and its network performance, and creates subtasks from those tasks, and transmits the subtasks for distribution to interface devices), one or more subtasks (e.g., “determine upload speeds on AT&T′s network at your location”) that correspond to one or more tasks of acquiring data (“determine which portions of Washington D.C. serviced by AT&T receive average upload speeds of less than 100 Kbps”), wherein the task of acquiring data is configured to be carried out by two or more discrete interface devices (e.g., the task of “determine which portions of Washington D.C. serviced by AT&T receive average upload speeds of less than 100 Kbps” may be carried out by a wireless hotspot card in Adams Morgan and a Pantech Breakout cellular phone in DuPont Circle).

Referring again to FIG. 5A, operation 508 may include operation 512 depicting receiving, from an external subtask creator provided by an interface device vendor, one or more subtasks that correspond to one or more tasks of acquiring data, wherein the task of acquiring data is configured to be carried out by two or more discrete interface devices. For example, FIG. 2A shows interface device vendor providing discrete interface device subtask receiving module 212 receiving, from an external subtask creator provided by an interface device vendor (e.g., Samsung receives tasks from users or creates tasks that assist in analyzing its business, then breaks those tasks down into subtasks, then transmits the subtasks for distribution to interface devices), one or more subtasks (e.g., “determine how many visible wireless networks at your location are set up by Samsung-branded wireless routers”) that correspond to one or more tasks of acquiring data (e.g., “determine a Washington DC-based Samsung branded wireless router usage map”), wherein the task of acquiring data is configured to be carried out by two or more discrete interface devices (e.g., a set of Dell desktop computers in an office park in Arlington, Va., and a Microsoft Zune music player being used at a gym in Columbia Heights).

Referring again to FIG. 5A, operation 508 may include operation 514 depicting receiving, from an external subtask creator provided by an interface device operating system vendor, one or more subtasks that correspond to one or more tasks of acquiring data, wherein the task of acquiring data is configured to be carried out by two or more discrete interface devices. For example, FIG. 2A shows interface device operating system vendor providing discrete interface device subtask receiving module 214 receiving, from an external subtask creator provided by an interface device operating system (e.g., Android) vendor (e.g., Google receives task requests through its search engine, or creates tasks on its own, and creates subtasks based on the task, either using its computers, servers, and people, or contracting other computers, servers, and people to create the subtasks), one or more subtasks (e.g., “determine the average wireless signal strength for your location”) that correspond to one or more tasks of acquiring data (e.g., “determine the wireless signal penetration for the downtown area of ten U.S. cities for targeting development”), wherein the task of acquiring data is configured to be carried out by two or more discrete interface devices (e.g., an HP touchpad in Kansas City, Mo., and a Panasonic Wireless-ready TV in Bloomington, Ill.).

Referring now to FIG. 5B, operation 402 may include operation 516 depicting retrieving one or more subtasks that correspond to one or more tasks of acquiring data, wherein the task of acquiring data is configured to be carried out by two or more discrete interface devices. For example, FIG. 2A shows task portion two-or-more discrete interface device subtask retrieving module 216 retrieving (e.g., accessing, from a memory or database, either external or internal, e.g., Paramount Theater may keep a repository of subtasks for completion) one or more subtasks (e.g., “determine how many empty seats are at the movie theater at your location”) that correspond to one or more tasks of acquiring data (e.g., “determine which opening night movies on September 30 had the most packed theaters”), wherein the task of acquiring data is configured to be carried out by two or more discrete interface devices (e.g., using the camera of an iPhone 5, and querying the operator of a basic Sprint smartphone with no camera).

Referring again to FIG. 5B, operation 402 may include operation 526 depicting creating one or more subtasks that correspond to portions of a task of acquiring data, wherein the task of acquiring data is configured to be carried out by two or more discrete interface devices. For example, FIG. 2A shows discrete interface device subtask creating module 226 creating (e.g., using either human intervention or computing power to derive the one or more subtasks that will allow completion of the task) one or more subtasks (e.g., “determine whether your table at La Tasca has a view of the Puget Sound”) that correspond to portions of a task of acquiring data (e.g., “determine which restaurant on 4^{th} street has the most tables with Puget Sound views”), wherein the task of acquiring data is configured to be carried out by two or more discrete interface devices (e.g., collecting image data from a BlackBerry Torch, querying a Samsung Galaxy II).

Referring now to FIG. 5C, operation 402 may include operation 528 depicting generating one or more subtasks that correspond to portions of a task of acquiring data, wherein the task of acquiring data is configured to be carried out by two or more discrete interface devices. For example, FIG. 2A shows discrete interface device subtask generating module 228 generating (e.g., using either human intervention or computing power applied to the task of acquiring data to determine one or more subtasks) one or more subtasks (e.g., “take a picture of Times Square at 6 am”) that correspond to portions of a task of acquiring data (e.g., “obtain a time-lapse snapshot of Times Square from 6 am to 9 am on a weekday”), wherein the task of acquiring data is configured to be carried out by two or more discrete interface devices (e.g., a traffic camera on 37^{th} street, and a Wells Fargo ATM camera on 109^{th} street).

Referring again to FIG. 5C, operation 402 may include operation 530 depicting selecting one or more subtasks that correspond to portions of a task of acquiring data, wherein the task of acquiring data is configured to be carried out by two or more discrete interface devices. For example, FIG. 2A shows two-or-more discrete interface device subtask selecting module 230 selecting (e.g., picking subtasks from a list, or a database of subtasks, e.g., a list or database of previously executed subtasks, e.g., in response to a request to carry out a task) one or more subtasks (e.g., “determine how fast you are moving across the I-90 bridge at your location”) that correspond to portions of a task of acquiring data (e.g., “determine how much traffic is on the I-90 bridge throughout the day”), wherein the task of acquiring data is configured to be carried out by two or more discrete interface devices (e.g., an iPhone in glove box of a Mercedes-Benz, and an OnStar equipped GMC Envoy system).

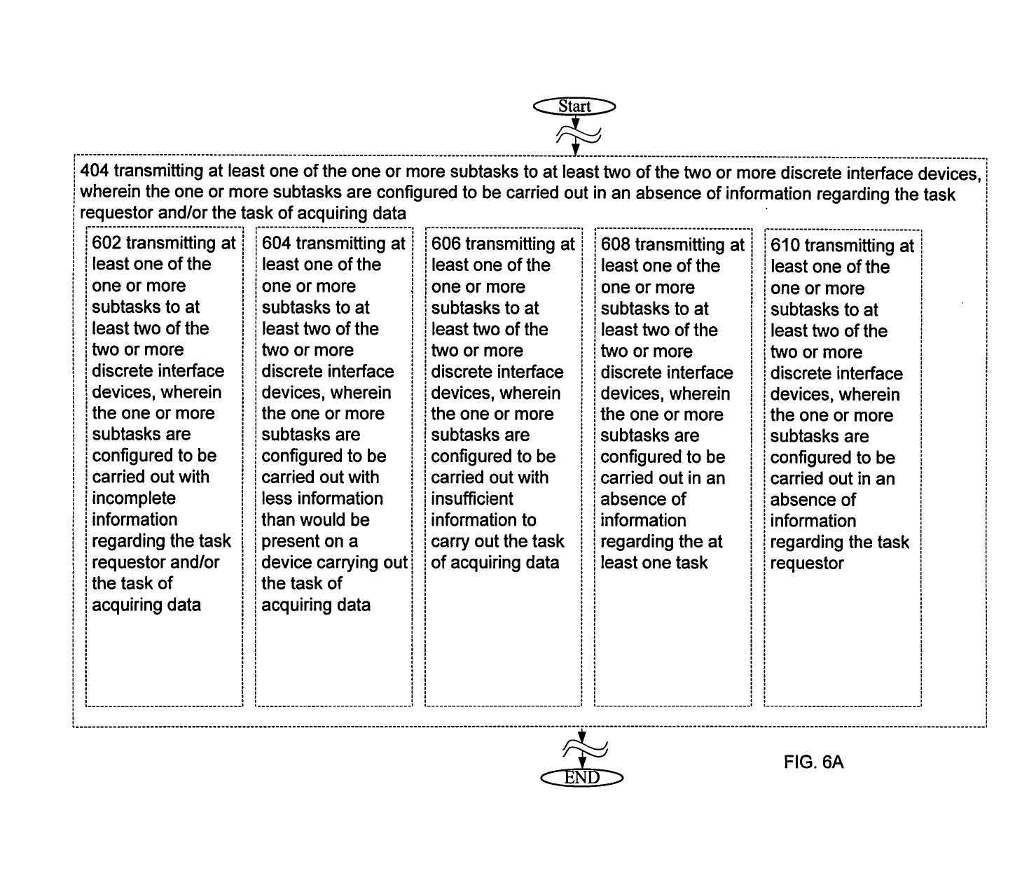

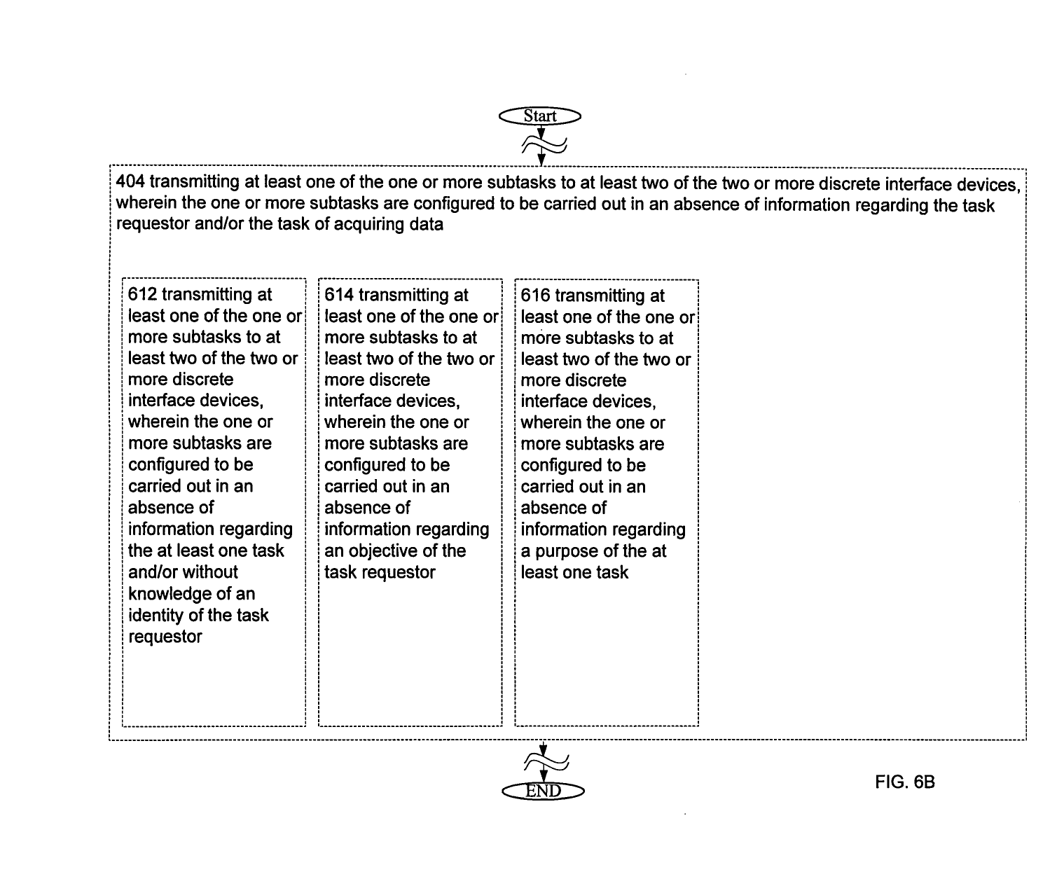

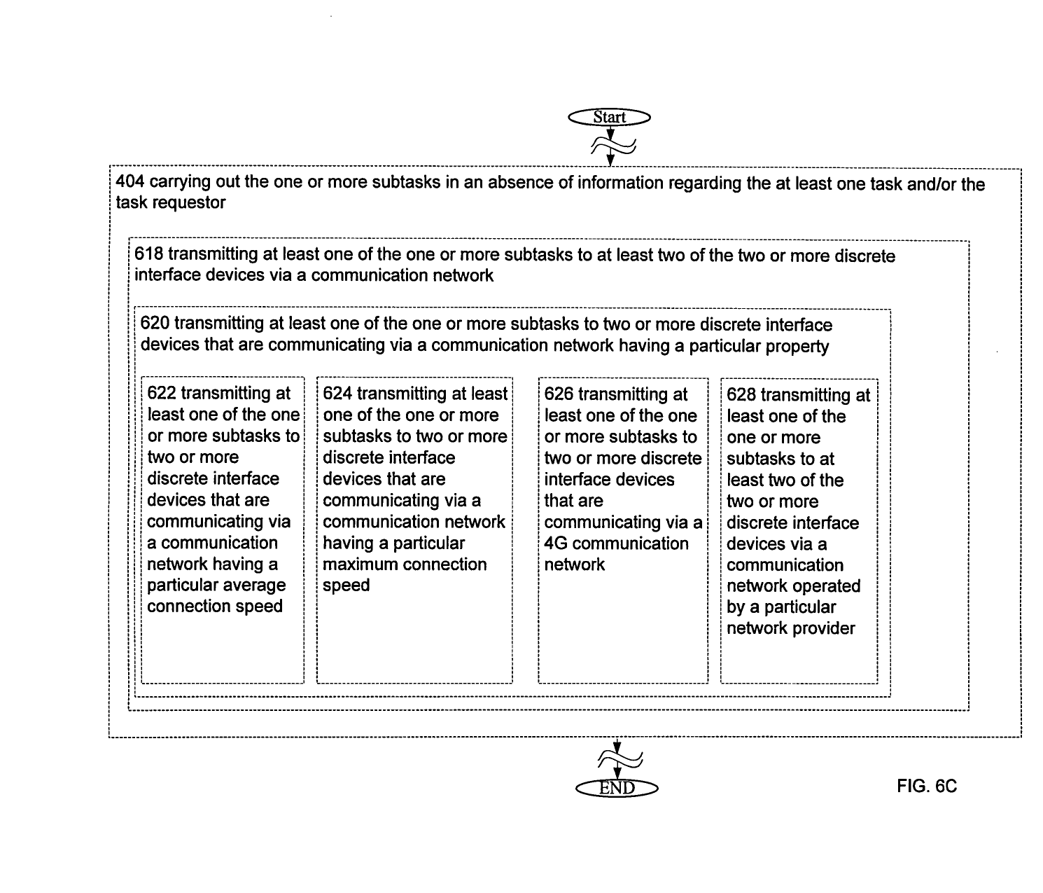

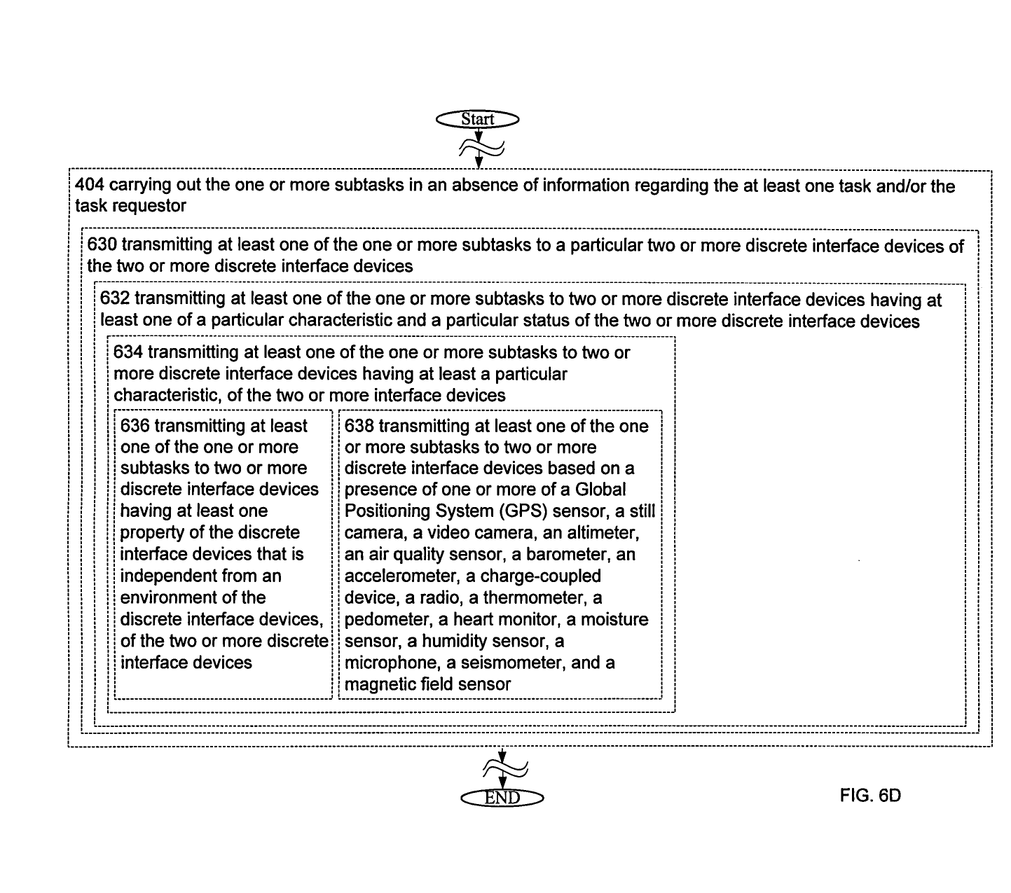

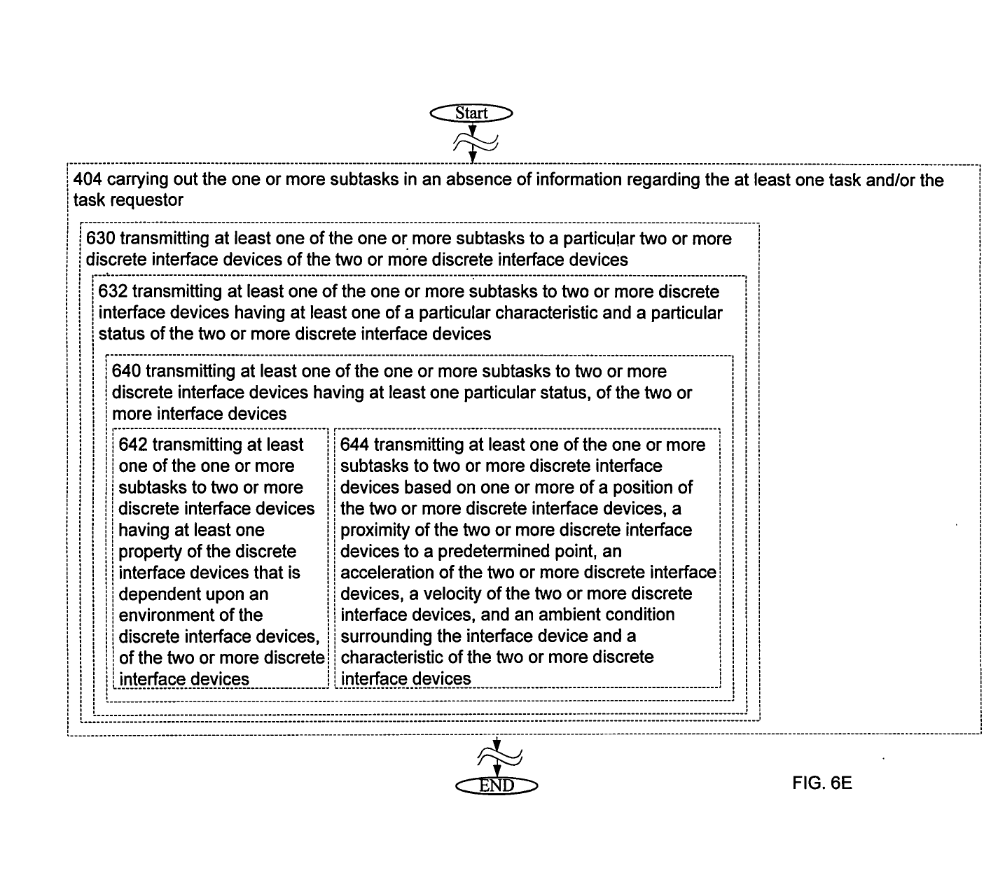

FIGS. 6A 6E depict various implementations of operation 404, according to various embodiments. Referring now to FIG. 6A, operation 404 may include operation 602 depicting transmitting at least one of the one or more subtasks to at least two of the two or more discrete interface devices, wherein the one or more subtasks are configured to be carried out with incomplete information regarding the task requestor and/or the task of acquiring data. For example, FIG. 2B shows incomplete information of task and/or task requestor subtask transmitting module 232 transmitting at least one of the one or more subtasks (e.g., “determine how fast you are moving across the I-90 bridge at your location”) to at least two of the two or more discrete interface devices (e.g., an iPhone in a glove box, and a Nokia E5 in a passenger's pocket), wherein the one or more subtasks are configured to be carried out with incomplete information regarding the task requestor (e.g., the iPhone and Nokia E5 do not know the identity of the task requestor or the type of entity, e.g., personal, corporate, automated) and/or the task of acquiring data (e.g., the task of “determine the fastest way into Seattle at 4:25 PM from Bellevue, Wash.,” the iPhone and the Nokia E5 do not know the task, and whether it is “determine the fastest way,” or “monitor traffic conditions,” or any details about how the information the devices are gathering will be used, and to answer which queries.)

Referring again to FIG. 6A, operation 404 may include operation 604 depicting transmitting at least one of the one or more subtasks to at least two of the two or more discrete interface devices, wherein the one or more subtasks are configured to be carried out with less information than would be present on a device carrying out the task of acquiring data. For example, FIG. 2B shows less information of task and/or task requestor subtask transmitting module 234 transmitting at least one of the one or more subtasks (e.g., “determine the view from your location at Safeco field”) to at least two of the two or more discrete interface devices (e.g., a Samsung Galaxy II and a Motorola Droid 3), wherein the one or more subtasks are configured to be carried out with less information than would be present on a device carrying out the task of acquiring data (e.g., the Samsung Galaxy II and the Droid 3 only activate their image collecting component and collect data. The task is “determine how full the rows are in the upper deck at Safeco Field.” The devices have no idea whether they are capturing images of the fans in the stands, of the view, of the weather, of the sunlight, or of the best time to avoid shadows, or to determine whether the seats are covered. In contrast, a device carrying out the task by itself (which would have to go to each row of the park) would know to determine how full the rows are because of knowledge of the task).

Referring again to FIG. 6A, operation 404 may include operation 606 depicting transmitting at least one of the one or more subtasks to at least two of the two or more discrete interface devices, wherein the one or more subtasks are configured to be carried out with insufficient information to carry out the task of acquiring data. For example, FIG. 2B shows insufficient information of task and/or task requestor subtask transmitting module 236 transmitting at least one of the one or more subtasks (e.g., “determine the wireless network strength at McDonald's in Bellevue, Wash.) to at least two of the two or more discrete interface devices (e.g., a Droid Revolution and a Nokia E650 smartphone), wherein the one or more subtasks are configured to be carried out with insufficient information to carry out the task of acquiring data (e.g., the task of acquiring data is “determine which McDonald's of the ones in Bellevue, Wash., have the fastest interne connection.” The interface devices have insufficient information to complete this task because they are merely measuring wireless strength at McDonald's. They do not know whether to measure strength at various McDonald's, various types of signal strength at that McDonald's (e.g., cellular network strength), whether to measure the signal strength at a particular time, or over a particular period of time. The Droid Revolution and the Nokia E650 have insufficient information to carry out the entire task, but are capable of carrying out the subtask that was transmitted to them).

Referring again to FIG. 6A, operation 404 may include operation 608 depicting transmitting at least one of the one or more subtasks to at least two of the two or more discrete interface devices, wherein the one or more subtasks are configured to be carried out in an absence of information regarding the at least one task. For example, FIG. 2B shows absent task information subtask transmitting module 238 transmitting at least one of the one or more subtasks (e.g., “take a picture in near-real time of Times Square”) to at least two of the two or more discrete interface devices (e.g., Samsung Epic Touch smartphone, HTC Evo smartphone), wherein the one or more subtasks are configured to be carried out in an absence of information regarding the at least one task (e.g., the task is “take a 360-degree picture of Times Square when the new Reebok ad pops up at 8:01:32 a.m.,” and the discrete interface devices do not have the information that this is the task).

Referring again to FIG. 6A, operation 404 may include operation 610 depicting transmitting at least one of the one or more subtasks to at least two of the two or more discrete interface devices, wherein the one or more subtasks are configured to be carried out in an absence of information regarding the task requestor. For example, FIG. 2B shows absent task requestor information subtask transmitting module 240 transmitting at least one of the one or more subtasks (.e.g., “take a picture in near-real time of Times Square”) to at least two of the two or more discrete interface devices (e.g., Samsung Epic Touch smartphone, HTC Evo smartphone), wherein the one or more subtasks are configured to be carried out in an absence of information regarding the at least one task (e.g., the task is “take a 360-degree picture of Times Square when the new Reebok ad pops up at 8:01:32 a.m.,” and the task requestor is Reebok, and the discrete interface devices do not have the information regarding the task requestor, e.g., identity, or which type, e.g., corporate or personal, human or machine query).

Referring now to FIG. 6B, operation 404 may include operation 612 depicting transmitting at least one of the one or more subtasks to at least two of the two or more discrete interface devices, wherein the one or more subtasks are configured to be carried out in an absence of information regarding the at least one task and/or without knowledge of an identity of the task requestor. For example, FIG. 2B shows absent knowledge of task requestor identity subtask transmitting module 242

Referring again to FIG. 6B, operation 404 may include operation 614 depicting transmitting at least one of the one or more subtasks to at least two of the two or more discrete interface devices, wherein the one or more subtasks are configured to be carried out in an absence of information regarding an objective of the task requestor. For example, FIG. 2B shows absent knowledge of task requestor objective subtask transmitting module 244 transmitting at least one of the one or more subtasks (e.g., “how many sticky buns are left at the bakery/coffee shop at your present location”) to at least two of the two or more discrete interface devices (e.g., an iPhone 4G and a Droid Bionic), wherein the one or more subtasks are configured to be carried out in an absence of information regarding an objective of the task requestor (e.g., the task requestor may be trying to determine where he could purchase the most sticky buns, or it may be a corporate computer trying to determine inventory patterns, or the task requestor could be determining how many calories are available for consumption on various city blocks in Seattle. The task requestor's objective is left unknown to the interface device, even if the interface device knows the identity of the task requestor).

Referring again to FIG. 6B, operation 404 may include operation 616 depicting transmitting at least one of the one or more subtasks to at least two of the two or more discrete interface devices, wherein the one or more subtasks are configured to be carried out in an absence of information regarding a purpose of the at least one task. For example, FIG. 2B shows absent knowledge of task purpose subtask transmitting module 246 transmitting at least one of the one or more subtasks (e.g., “how much rain fell in your location in the last six hours”) to at least two of the two or more discrete interface devices (e.g., a smartphone with a precipitation detector, and a smartphone where the user is queried for an answer), wherein the one or more subtasks are configured to be carried out in an absence of information regarding a purpose of the at least one task (e.g., the smartphones carrying out the task do not know if the purpose is to “track rainfall” or “determine where to visit in order to get sunshine,” or “predict the weather patterns moving east”).

Referring now to FIG. 6C, operation 404 may include operation 618 depicting transmitting at least one of the one or more subtasks to at least two of the two or more discrete interface devices via a communication network. For example, FIG. 2B shows communication network absent knowledge subtask transmitting module 248 transmitting at least one of the one or more subtasks (e.g., “determine how many people exactly are watching “Sons of Anarchy”) to at least two of the two or more discrete interface devices (e.g., WiFi enabled Sony and Panasonic televisions) via a communication network (e.g., a series of wireless networks, or a cellular network used by, e.g., AT&T)

Referring again to FIG. 6C, operation 618 may include operation 620 depicting transmitting at least one of the one or more subtasks to two or more discrete interface devices that are communicating via a communication network having a particular property. For example, FIG. 2B shows communication network having particular property subtask transmitting module 250 transmitting at least one of the one or more subtasks (e.g., “determine the wait to get into Emeril Lagasse's new restaurant”) to two or more discrete interface devices (e.g., the iPhone 4G and the Nokia E5”) that are communicating via a communication network (e.g., a cellular network) having a particular property (e.g., the AT&T network, which has a property of “has coverage over Emeril Lagasse's new restaurant”).

Referring again to FIG. 6C, operation 620 may include operation 622 depicting transmitting at least one of the one or more subtasks to two or more discrete interface devices that are communicating via a communication network having a particular average connection speed. For example, FIG. 2B shows communication network having particular average connection speed subtask transmitting module 252 transmitting at least one of the one or more subtasks (e.g., “determine the wait to get into the theater to see Iron Man 3”) to two or more discrete interface devices (e.g., Samsung Focus Flash, Motorola Droid Razz) that are communicating via a communication network (e.g. T-Mobile's network) having a particular average connection speed (e.g., 3 Mb/s).

Referring again to FIG. 6C, operation 620 may include operation 624 depicting transmitting at least one of the one or more subtasks to two or more discrete interface devices that are communicating via a communication network having a particular maximum connection speed. For example, FIG. 2B shows communication network having particular maximum connection speed subtask transmitting module 254 transmitting at least one of the one or more subtasks (e.g., “determine the humidity at your current location”) to two or more discrete interface devices (e.g., a weather station on Queen Anne Blvd., and a smartphone having a humidity sensor) that are communicating via a communication network (e.g., Verizon's 4G LTE network”) having a particular maximum connection speed (e.g., 12 Mb/s).

Referring again to FIG. 6C, operation 620 may include operation 626 depicting transmitting at least one of the one or more subtasks to two or more discrete interface devices that are communicating via a 4G communication network. For example, FIG. 2B shows communication network having 4G connection subtask transmitting module 256 transmitting at least one of the one or more subtasks (e.g., “determine the wait to get into the bar where Mike Tyson is making a guest appearance”) to two or more discrete interface devices (e.g., the Droid Razz and the Droid Bionic) that are communicating via a 4G communication network (e.g., the Sprint 4G network).

Referring again to FIG. 6C, operation 620 may include operation 628 depicting transmitting at least one of the one or more subtasks to at least two of the two or more discrete interface devices via a communication network operated by a particular network provider. For example, FIG. 2B shows communication network having particular provider subtask transmitting module 258 transmitting at least one of the one or more subtasks (e.g., “determine if traffic is stopped at your location on the I-90 bridge”) to at least two of the two or more discrete interface devices (e.g., the iPhone 5 and the Nokia T580 smartphone) via a communication network operated by a particular network provider (e.g., Verizon's cellular network).

Referring now to FIG. 6D, operation 404 may include operation 630 depicting transmitting at least one of the one or more subtasks to a particular two or more discrete interface devices of the two or more discrete interface devices. For example, FIG. 2B shows particular interface devices subtask transmitting module 260 transmitting at least one of the one or more subtasks (e.g., “determine the wind speed on the 520 Bridge between Seattle and Bellevue at your location on the bridge”) to a particular two or more discrete interface devices (e.g., an iPhone 4G and a Blackberry Torch) of the two or more discrete interface devices.

Referring again to FIG. 6D, operation 630 may include operation 632 depicting transmitting at least one of the one or more subtasks to two or more discrete interface devices having at least one of a particular characteristic and a particular status of the two or more discrete interface devices. For example, FIG. 2B shows particular interface devices having at least one particular characteristic and/or status subtask transmitting module 262 transmitting at least one of the one or more subtasks (e.g. “determine the loudness at the Pearl Jam concert at your location”) to two or more discrete interface devices (e.g., the Samsung Focus Flash and the Samsung Galaxy SII) having at least one of a particular characteristic (e.g., “has a microphone”) and a particular status (e.g., is positioned within the concert hall) of the two or more discrete interface devices.

Referring again to FIG. 6D, operation 632 may include operation 634 depicting transmitting at least one of the one or more subtasks to two or more discrete interface devices having at least a particular characteristic, of the two or more interface devices. For example, FIG. 2B shows particular interface devices having at least one particular characteristic subtask transmitting module 264 transmitting at least one of the one or more subtasks (e.g., “determine the loudness at the Pearl Jam concert at your location”) to two or more discrete interface devices (e.g., the Samsung Galaxy SII and the Motorola Droid Razr) having at least a particular characteristic (e.g., having a microphone of sensitivity within 2 mV/PA), of the two or more interface devices.

Referring again to FIG. 6D, operation 634 may include operation 636 depicting transmitting at least one of the one or more subtasks to two or more discrete interface devices having at least one property of the discrete interface devices that is independent from an environment of the discrete interface devices, of the two or more discrete interface devices. For example, FIG. 2B shows particular interface devices having at least one environment-independent property subtask transmitting module 266 transmitting at least one of the one or more subtasks (e.g., “determine the loudness at the Pearl Jam concert at your location”) to two or more discrete interface devices (e.g., the Samsung Galaxy SII and the iPhone 4S”) having at least one property that is independent from an environment of the discrete interface device (e.g., “has a video camera for taking video data in addition to audio data”), of the two or more discrete interface devices.

Referring again to FIG. 6D, operation 634 may include operation 638 depicting transmitting at least one of the one or more subtasks to two or more discrete interface devices based on a presence of one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor. For example, FIG. 2B shows particular interface devices having at least one of a list of characteristics subtask transmitting module 268 transmitting at least one of the one or more subtasks (e.g., “determine the humidity at your location”) to two or more discrete interface devices (e.g., two smartphones with humidity sensors) based on a presence of one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor.

Referring now to FIG. 6E, operation 632 may include operation 640 depicting transmitting at least one of the one or more subtasks to two or more discrete interface devices having at least one particular status, of the two or more interface devices. For example, FIG. 2B shows particular interface devices having at least one particular status subtask transmitting module 270 transmitting at least one of the one or more subtasks (e.g., “determine the loudness at the Pearl Jam concert at your location”) to two or more discrete interface devices (e.g., an iPhone 4S and a BlackBerry 8800) having at least one particular status (e.g., are positioned in the “floor seat” section of the stadium), of the two or more interface devices.

Referring again to FIG. 6E, operation 640 may include operation 642 depicting transmitting at least one of the one or more subtasks to two or more discrete interface devices having at least one property of the discrete interface devices that is dependent upon an environment of the discrete interface devices, of the two or more discrete interface devices. For example, FIG. 2B shows particular interface devices having at least one environment-dependent property subtask transmitting module 272 transmitting at least one of the one or more subtasks (e.g., “determine the loudness at the Pearl Jam concert at your location”) to two or more discrete interface devices (e.g., an iPhone 4 and a Pantech Breakout) having at least one property of the discrete interface devices that is dependent upon an environment of the discrete interface devices (e.g., the devices have an unobstructed line of sight to the stage), of the two or more discrete interface devices.

Referring again to FIG. 6E, operation 640 may include operation 644 depicting transmitting at least one of the one or more subtasks to two or more discrete interface devices based on one or more of a position of the two or more discrete interface devices, a proximity of the two or more discrete interface devices to a predetermined point, an acceleration of the two or more discrete interface devices, a velocity of the two or more discrete interface devices, and an ambient condition surrounding the interface device and a characteristic of the two or more discrete interface devices. For example, FIG. 2B shows particular interface devices having at least one of a list of statuses subtask transmitting module 274 transmitting at least one of the one or more subtasks (e.g., “determine the loudness at your location at Notre Dame Stadium”) to two or more discrete interface devices (e.g., a BlackBerry Bold and an iPhone 3) based on one or more of a position of the two or more discrete interface devices, a proximity of the two or more discrete interface devices to a predetermined point, an acceleration of the two or more discrete interface devices, a velocity of the two or more discrete interface devices, and an ambient condition surrounding the interface device and a characteristic of the two or more discrete interface devices.

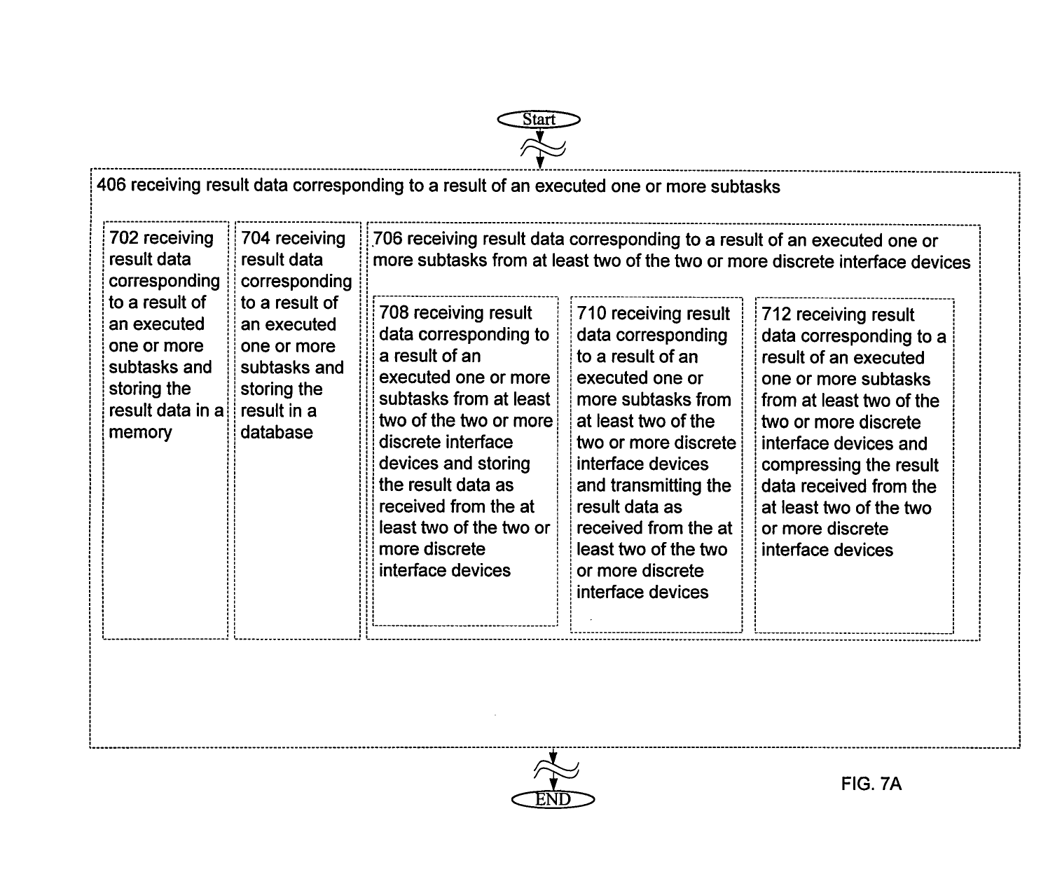

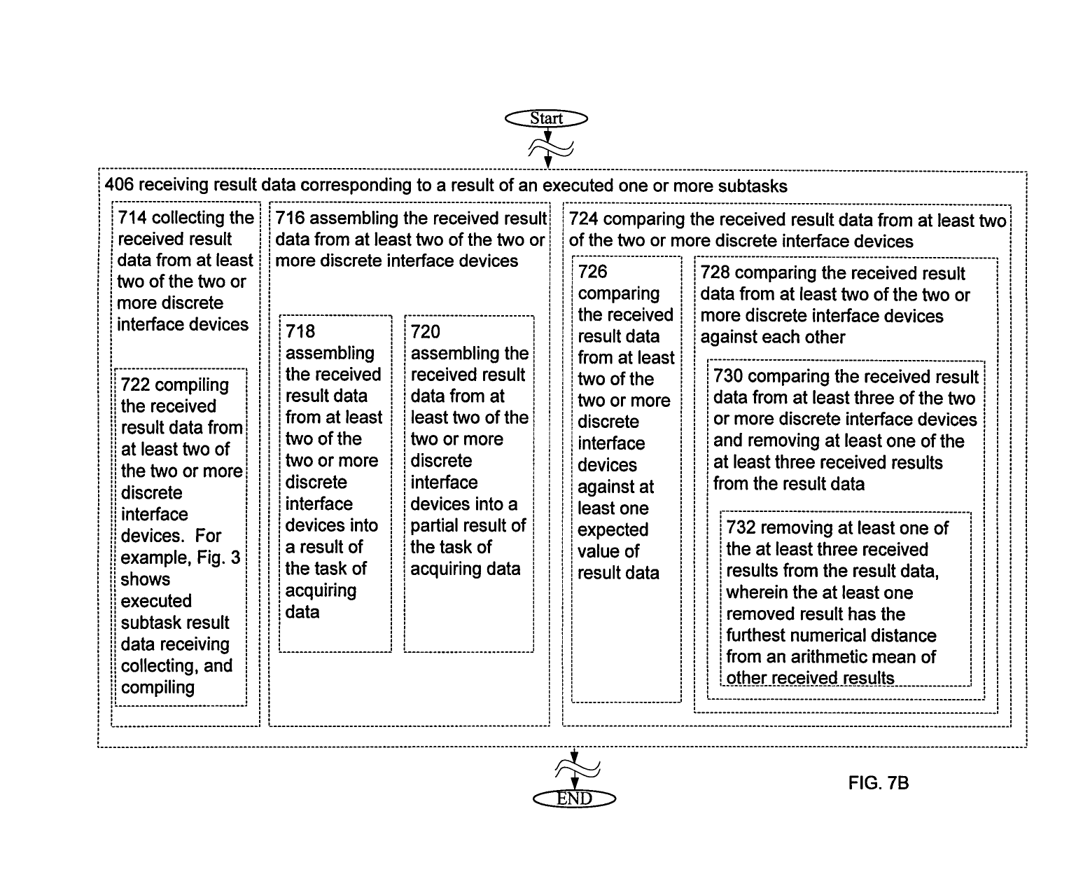

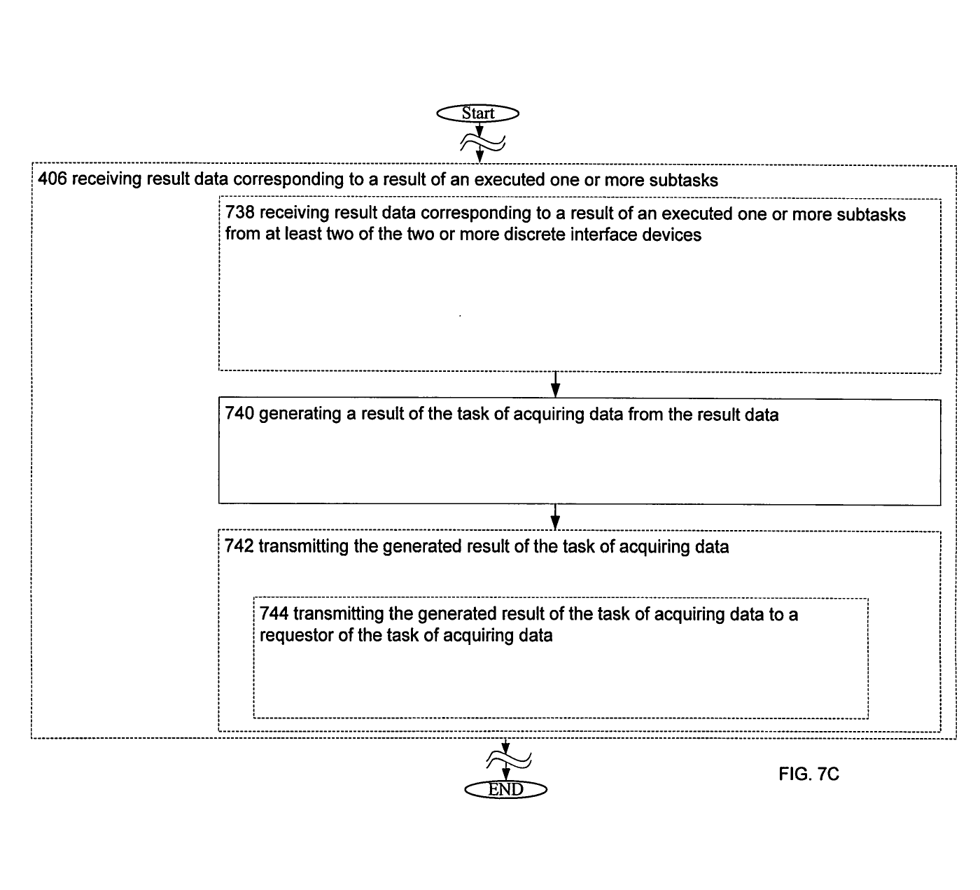

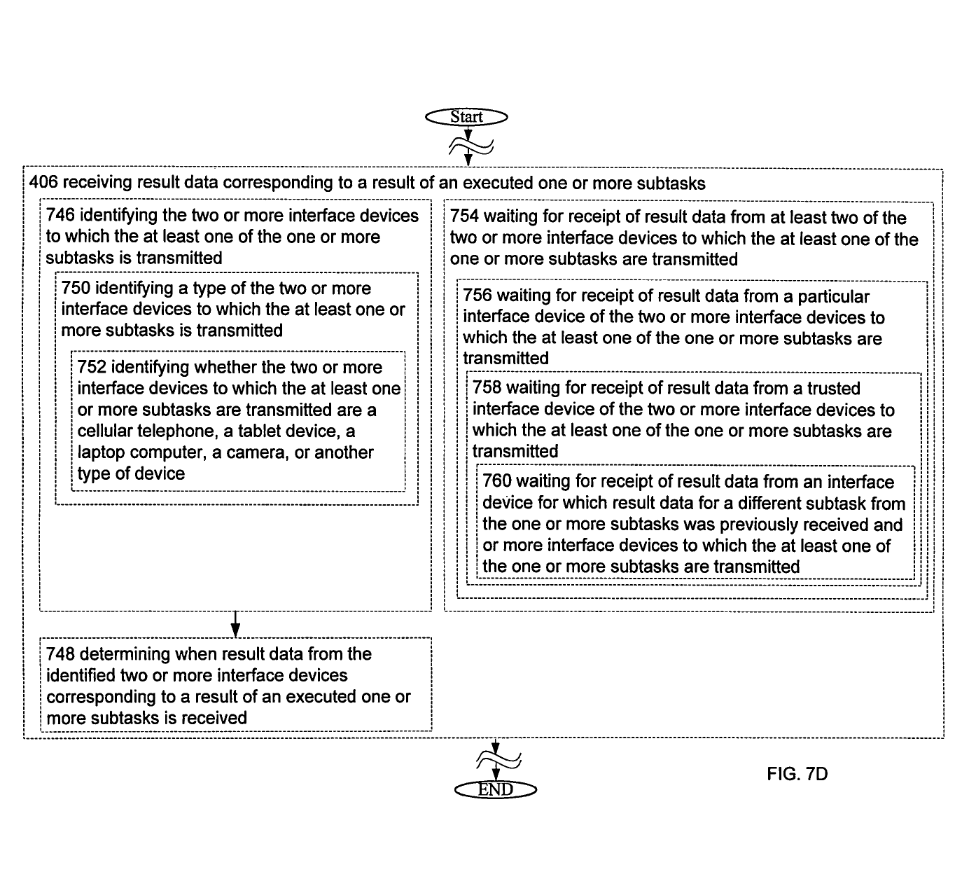

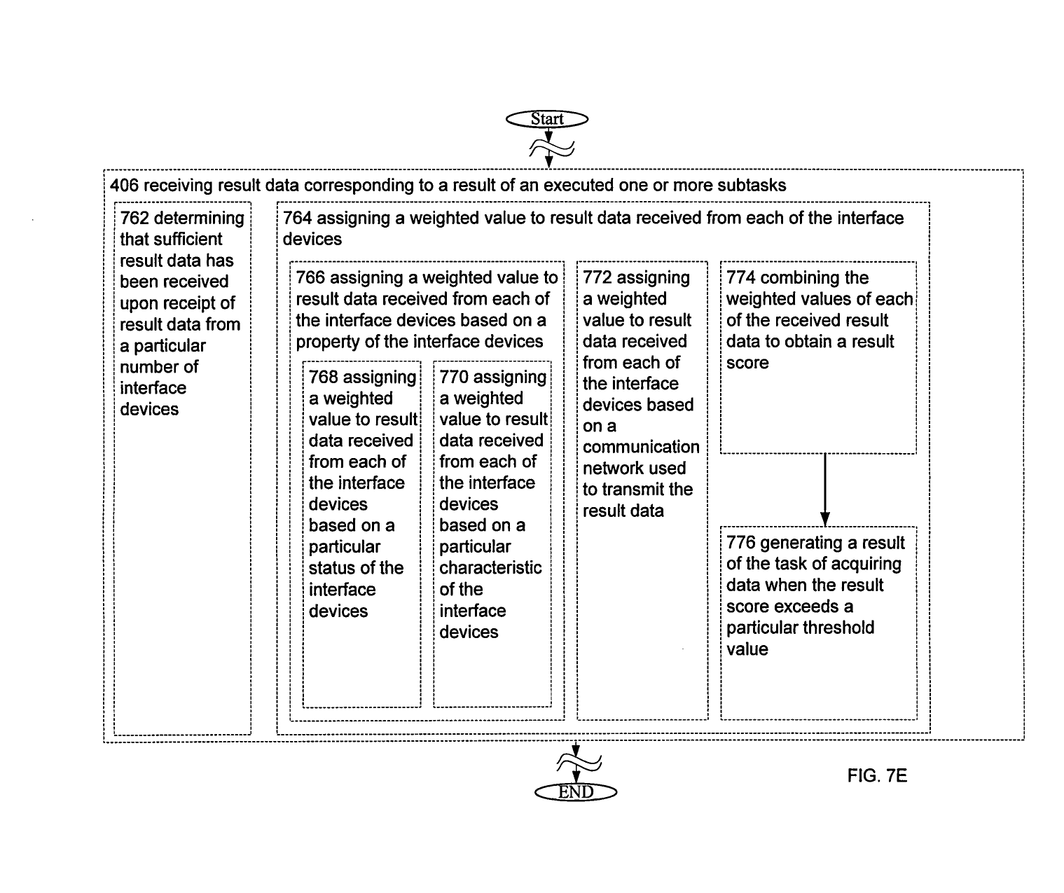

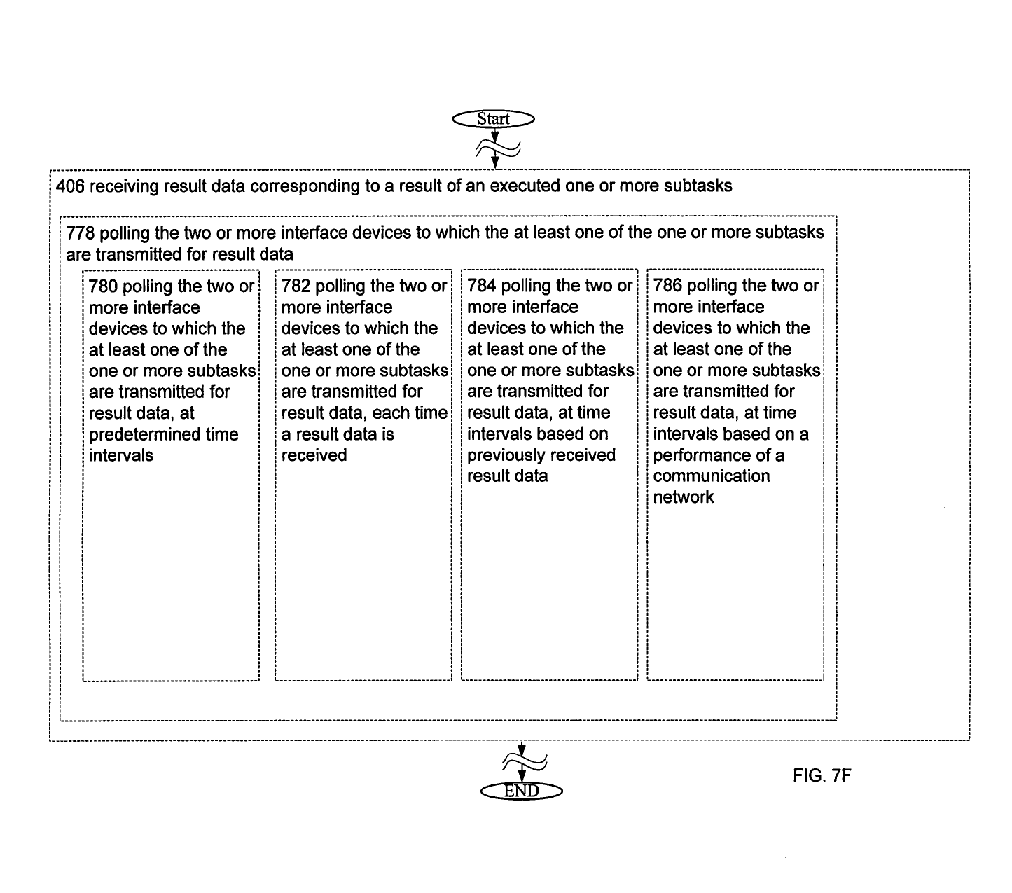

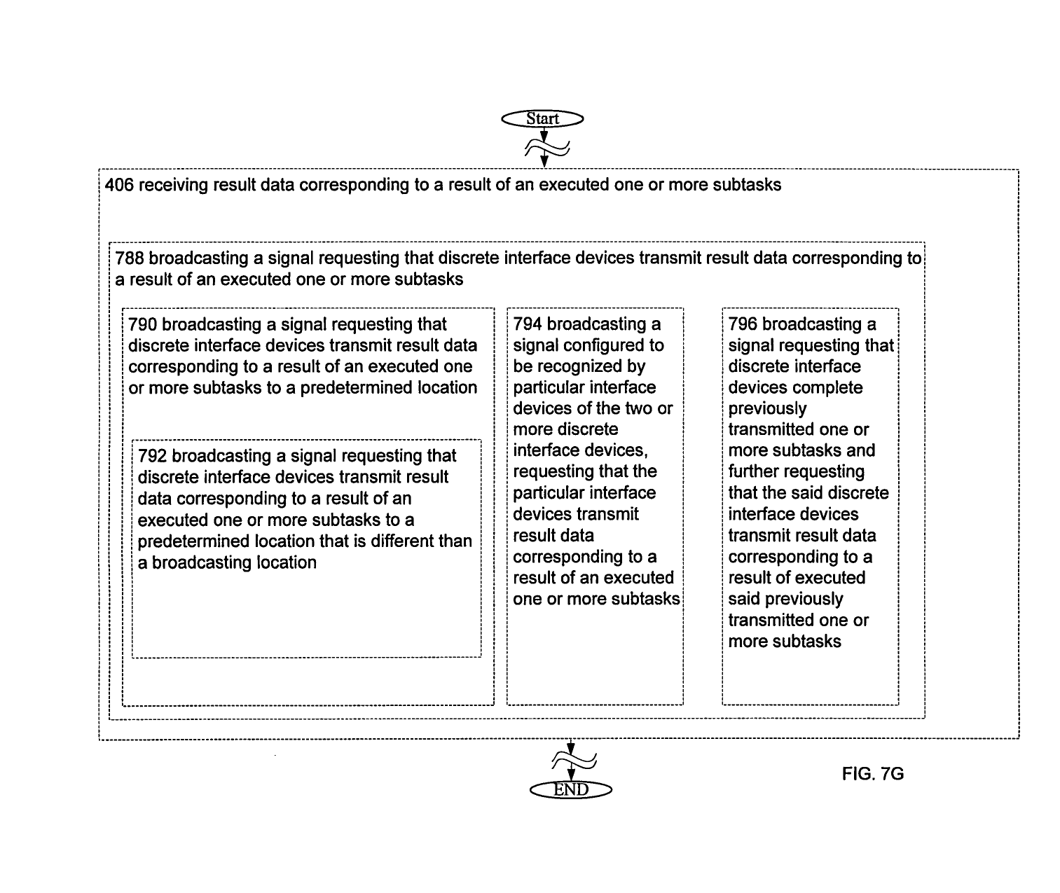

FIGS. 7A-7G depict various implementations of operation 406, according to embodiments. Referring now to FIG. 7A, operation 406 may include operation 702 depicting receiving result data corresponding to a result of an executed one or more subtasks and storing the result data in a memory. For example, FIG. 3 shows executed subtask result data receiving and memory storing module 302 receiving result data (e.g., image data) corresponding to a result of an executed one or more subtasks (e.g., “take a picture of Notre Dame stadium from your location”) and storing the result data in a memory (e.g., a hard drive of a server that receives the result data).

Referring again to FIG. 7A, operation 406 may include operation 704 depicting receiving result data corresponding to a result of an executed one or more subtasks and storing the result in a database. For example, FIG. 3 shows executed subtask result data receiving and database storing module 304 receiving result data (e.g., data regarding wireless network strength) corresponding to a result of an executed one or more subtasks (e.g., “measure the wireless network strength at your location”) and storing the result in a database (e.g., a data structure (e.g., an SQL database) designed with Oracle and residing on a server that receives the result data.

Referring again to FIG. 7A, operation 406 may include operation 706 depicting receiving result data corresponding to a result of an executed one or more subtasks from at least two of the two or more discrete interface devices. For example, FIG. 3 shows two or more discrete interface devices executed subtask result data receiving module 306 receiving result data (e.g., precipitation data tracked by location) corresponding to a result of an executed one or more subtasks (e.g., “determine the precipitation rate at your current location”) from at least two of the two or more discrete interface devices (e.g., thirty smartphones with precipitation sensors, positioned at different positions throughout Seattle, Wash.).

Referring again to FIG. 7A, operation 406 may include operation 708 depicting receiving result data corresponding to a result of an executed one or more subtasks from at least two of the two or more discrete interface devices and storing the result data as received from the at least two of the two or more discrete interface devices. For example, FIG. 3 shows two or more discrete interface devices executed subtask stored as received data receiving module 308 receiving result data (e.g., image data) corresponding to a result of an executed one or more subtasks (e.g., “take a picture of Times Square at 8:00 am) from at least two of the two or more discrete interface devices (e.g., a WiFi enabled camera, and the webcam of an ASUS EeePc) and storing the result data received from the at least two of the two or more discrete interface devices (e.g., storing the image data in a hard drive of a server receiving the result data).

Referring again to FIG. 7A, operation 706 may include operation 710 depicting receiving result data corresponding to a result of an executed one or more subtasks from at least two of the two or more discrete interface devices and transmitting the result data as received from the at least two of the two or more discrete interface devices. For example, FIG. 3 shows two or more discrete interface devices executed subtask transmitted as received data receiving module 310 receiving result data (e.g., decibel level data) corresponding to a result of an executed one or more subtasks (e.g., “determine the loudness of the Matt & Kim concert at your location”) from at least two of the two or more discrete interface devices (e.g., a Sony WiFi-enabled personal recorder, and an iPhone 4S) and transmitting the result data s received from the at least two of the two or more discrete interface devices (e.g., receiving the audio and streaming it as it is received to a new destination, e.g., the task requestor, or an intermediary subtask creator).

Referring again to FIG. 7A, operation 706 may include operation 712 depicting receiving result data corresponding to a result of an executed one or more subtasks from at least two of the two or more discrete interface devices and compressing the result data received from the at least two of the two or more discrete interface devices. For example, FIG. 3 shows two or more discrete interface devices compressed result data receiving module 312 receiving result data corresponding to a result of an executed one or more subtasks (e.g., “determine the loudness of the Matt & Kim concert at your location”) from at least two of the two or more discrete interface devices (e.g., a Sony WiFi-enabled personal recorder, and an iPhone 4S) and compressing the result data received from the at least two of the two or more discrete interface devices (e.g., compressing the audio received using MP3 or FLAC compression).

Referring now to FIG. 7B, operation 406 may include operation 714 depicting collecting the received result data from at least two of the two or more discrete interface devices. For example, FIG. 3 shows executed subtask result data receiving and collecting module 314 collecting the received result data (e.g., brightness data from a subtask of “determine the darkness of the movie theater at your current location”) from at least two of the two or more discrete interface devices (e.g., a Pantech Breakout and a Nokia E7).

Referring again to FIG. 7B, operation 406 may include operation 716 depicting assembling the received result data from at least two of the two or more discrete interface devices. For example, FIG. 3 shows executed subtask result data receiving and assembling module 316 assembling (e.g., receiving image data of the Eiffel tower and assembling the pictures together to achieve a 360-degree picture) the received result data (e.g., image data) from at least two of the two or more discrete interface devices (e.g., a Nikon WiFi-enabled camera and a Sony WiFi-enabled camcorder).

Referring again to FIG. 7B, operation 716 may include operation 718 depicting assembling the received result data from at least two of the two or more discrete interface devices into a result of the task of acquiring data. For example, FIG. 3 shows executed subtask result data receiving and assembling into task result module 318 assembling (e.g., receiving image data of the Eiffel tower and assembling the pictures together to achieve a 360-degree picture) the received result data (e.g., image data of the Eiffel Tower) from at least two of the two or more discrete interface devices (e.g., an Asus Transformer tablet and a HTC Flyer tablet) into a result of the task of acquiring data (e.g., a 360-degree picture of the Eiffel Tower).

Referring again to FIG. 7B, operation 716 may include operation 720 depicting assembling the received result data from at least two of the two or more discrete interface devices into a partial result of the task of acquiring data. For example, FIG. 3 shows executed subtask result data receiving and assembling into partial task result module 320 assembling (e.g., receiving wireless network strength data from twenty-five interface devices in the same McDonald's and combining them to determine a wireless network strength data for that McDonald's) from at least two of the two or more discrete interface devices (e.g., twenty-five smartphones in the same building) into a partial result of the task of acquiring data (e.g., the task of “determine which McDonald's in Bellevue has the strongest wireless interne signal,” and the result data is assembled to form a partial result, e.g., the result from one McDonald's, of the task of acquiring data.

Referring again to FIG. 7B, operation 714 may include operation 722 depicting compiling the received result data from at least two of the two or more discrete interface devices. For example, FIG. 3 shows executed subtask result data receiving collecting, and compiling module 322 compiling the received result data (e.g., precipitation data from five hundred smartphones detecting precipitation data is compiled into a weather tracking report tracking the exact movement of a storm system through the upper northwest) from at least two of the two or more discrete interface devices (e.g., five hundred smartphones equipped with a precipitation meter).

Referring again to FIG. 7B, operation 406 may include operation 724 depicting comparing the received result data from at least two of the two or more discrete interface devices. For example, FIG. 3 shows executed subtask result data receiving and comparing module 324 comparing the received result data (e.g., comparing wireless network strength data received from multiple interface devices in the same location, but which may have wireless radios of varying ability to detect network strength) from at least two of the two or more discrete interface devices (e.g., a Dell XPS 15 laptop and a Nook Color).

Referring again to FIG. 7B, operation 724 may include operation 726 depicting comparing the received result data from at least two of the two or more discrete interface devices against at least one expected value of result data. For example, FIG. 3 shows executed subtask result data receiving and comparing to expected value module 326 comparing the received result data (e.g., comparing the loudness data across multiple devices at the same point in a concert) from at least two of the two or more discrete interface devices (e.g., an iPhone 4S and an HTC Evo) against at least one expected value of result data (e.g., comparing the loudness data with a baseline value for loudness at a concert).

Referring again to FIG. 7B, operation 724 may include operation 728 depicting comparing the received result data from at least two of the two or more discrete interface devices against each other. For example, FIG. 3 shows executed subtask result data receiving and comparing against other received result data module 328 comparing the received result data (e.g., comparing the loudness data across multiple devices at the same point in a concert) from at least two of the two or more discrete interface devices (e.g., an iPhone 4S and an HTC Evo) against each other (e.g., comparing the loudness data for each device to determine whether there are any outliers).

Referring again to FIG. 7B, operation 728 may include operation 730 depicting comparing the received result data from at least three of the two or more discrete interface devices and removing at least one of the at least three received results from the result data. For example, FIG. 3 shows executed subtask result data receiving and comparing, and removing received result data module 330 comparing the received result data (e.g., comparing the loudness data across multiple devices at the same point in a concert) from at least three of the two or more discrete interface devices (e.g., an iPhone 4S, a Sony personal recorder, and a microphone of a Samsung Galaxy Tab) and removing at least one of the at least three received results from the result data (e.g., removing the Sony personal recorder data, which even though it may be more accurate, may be unsuitable for comparative tasks which require a large sampling of microphones that can only be accomplished using smartphone microphones).

Referring again to FIG. 7B, operation 730 may include operation 732 depicting removing at least one of the at least three received results from the result data, wherein the at least one removed result has the furthest numerical distance from an arithmetic mean of other received results. For example, FIG. 3 shows executed subtask result data receiving and comparing, and removing furthest away received result data module 332 removing at least one of the at least three received results from the result data (e.g., removing the result data from the Samsung Galaxy Tab), wherein the at least one removed result has the furthest numerical distance from an arithmetic mean of other received results (e.g., the iPhone 4S determines the loudness to be 111 dB, the Sony personal recorder determines the loudness to be 109 dB, and the Samsung Galaxy Tab determines the loudness to be 80 dB, then the arithmetic mean will be 100 db, and the Samsung Galaxy Tab data will be removed because 80 is further from 100 than 109 or 111).

Referring again to FIG. 7C, operation 406 may include operation 738 depicting receiving result data corresponding to a result of an executed one or more subtasks from at least two of the two or more discrete interface devices. For example, FIG. 3 shows at least two interface device executed subtask result data receiving module 338 receiving result data (e.g., image data) corresponding to a result of an executed one or more subtasks (e.g., “take a picture of Puget Sound as the sun sets,” to complete a task of “determine a time of sunset in Seattle, Wash.”) from at least two of the two or more discrete interface devices (e.g., an iPhone 4S and an iPad).

Referring again to FIG. 7C, operation 406 may further include operation 740 depicting generating a result of the task of acquiring data from the result data. For example, FIG. 3 shows task result from result data generating module 340 generating a result (e.g., taking the image data and determining a time that the sun has set based on the brightness data from the image data) of the task of acquiring data (e.g., “determine a time of sunset in Seattle, Wash.”) from the result data (e.g., the image data).

Referring again to FIG. 7C, operation 406 may further include operation 742 depicting transmitting the generated result of the task of acquiring data. For example, FIG. 3 shows generated task result transmitting module 342 transmitting (e.g., sending, to a task requestor or to a third party intermediary) the generated result (e.g., the determined time of sunset) of the task of acquiring data (e.g., “determine a time of sunset in Seattle, Wash.”).

Referring again to FIG. 7C, operation 742 may include operation 744 depicting transmitting the generated result of the task of acquiring data to a requestor of the task of acquiring data. For example, FIG. 3 shows generated task result task requestor transmitting module 344 transmitting (e.g., sending, to a task requestor) the generated result (e.g., the determined time of sunset) of the task of acquiring data (e.g., “determine a time of sunset in Seattle, Wash.”) to a requestor of the task of acquiring data (e.g., sending to the server that carried out a task requested by a person, or sending directly to the person that requested the task).

Referring now to FIG. 7D, operation 406 may include operation 746 depicting identifying the two or more interface devices to which the at least one of the one or more subtasks is transmitted. For example, FIG. 3 shows transmitted subtask interface device identifying module 346 identifying (e.g., determining a unique ID for, e.g., a MAC address, or a uniquely assigned ID) the two or more interface devices (e.g., John Smith's iPhone, and Sally Jones's iPad) to which the at least one or more subtasks (e.g., “determine the closest food truck to your location”).

Referring again to FIG. 7D, operation 406 may include operation 748 depicting determining when result data from the identified two or more interface devices corresponding to a result of an executed one or more subtasks is received. For example, FIG. 3 shows determining identified interface device executed subtask result data receiving module 348 determining when (e.g., triggering an action upon receipt) result data (e.g., location data of the closest food truck) from the identified two or more interface devices (e.g., “e.g., John Smith's iPhone, and Sally Jones's iPad) corresponding to a result of an executed one or more subtasks (e.g., “determine the closest food truck to your location”) is received.

Referring again to FIG. 7D, operation 746 may further include operation 750 depicting identifying a type of the two or more interface devices to which the at least one or more subtasks is transmitted. For example, FIG. 3 shows transmitted subtask interface device type identifying module 350 identifying a type of the two or more interface devices (e.g., a tablet and a smartphone) to which the at least one or more subtasks (e.g., “determine whether your seat at Safeco field has a view of the Jumbotron”) is transmitted.

Referring again to FIG. 7D, operation 750 may further include operation 752 depicting identifying whether the two or more interface devices to which the at least one or more subtasks are transmitted are a cellular telephone, a tablet device, a laptop computer, a camera, or another type of device. For example, FIG. 3 shows transmitted subtask interface device specific types identifying module 352 identifying whether the two or more interface devices (e.g., a tablet and a cellular telephone) to which the at least one or more subtasks (e.g., “respond to a query regarding whether your location currently has power”) are transmitted are a cellular telephone, a tablet device, a laptop computer, a camera, or another type of device.

Referring again to FIG. 7D, operation 406 may further include operation 754 depicting waiting for receipt of result data from at least two of the two or more interface devices to which the at least one of the one or more subtasks are transmitted. For example, FIG. 3 shows waiting for two-or-more interface device result data receiving module 354 waiting for receipt of result data (e.g., location data of a food truck) from at least two of the two or more interface devices (e.g., an iPhone and an iPad) to which the at least one of the one or more subtasks (e.g., determine the closest food truck selling nacho cheese”) are transmitted.

Referring again to FIG. 7D, operation 754 may further include operation 756 depicting waiting for receipt of result data from a particular interface device of the two or more interface devices to which the at least one of the one or more subtasks are transmitted. For example, FIG. 3 shows waiting for particular interface device result data receiving module 356 waiting for receipt of result data (e.g., a response to a query regarding “how many people are in line in front of you at the concession stand”) from a particular interface device (e.g., an iPhone of a person located at a position in front of a particular concession stand at Safeco field) of the two or more interface devices (e.g., every iPhone located within Safeco field) to which the at least one of the one or more subtasks (e.g., “respond to a query regarding how many people are in line in front of you”) are transmitted.

Referring again to FIG. 7D, operation 756 may further include operation 758 depicting waiting for receipt of result data from a trusted interface device of the two or more interface devices to which the at least one of the one or more subtasks are transmitted. For example, FIG. 3 shows waiting for trusted interface device result data receiving module 358 waiting for receipt of result data (e.g., a response to a query regarding “how many people are in line in front of you at the concession stand”) from a trusted interface device (e.g., an iPhone that has previously responded to a different subtask with information that was later deemed to be reliable) of the two or more interface devices (e.g., every iPhone located within Safeco field) to which the at least one of the one or more subtasks (e.g., “respond to a query regarding how many people are in line in front of you”) are transmitted.

Referring again to FIG. 7D, operation 406 may include operation 760 depicting waiting for receipt of result data from an interface device for which result data for a different subtask from the one or more subtasks was previously received. For example, FIG. 3 shows waiting for previously-executed subtask interface device result data receiving module 360 shows waiting for receipt of result data (e.g., image data) from an interface device (e.g., an iPhone) for which result data for a different subtask from the one or more subtasks (e.g., the previous subtask was “take a picture of Times Square,” and the current subtask is “take a picture of the Empire State Building”) was previously received.

Referring now to FIG. 7E, operation 406 may include operation 762 depicting determining that sufficient result data has been received upon receipt of result data from a particular number of interface devices. For example, FIG. 3 shows determining receipt of sufficient result data based on particular number of interface devices result data receiving module 362 determining that sufficient result data (e.g., enough image data) has been received upon receipt of result data from a particular number of interface devices (e.g., deciding that image data from 50 interface devices is sufficient to respond to the task of acquiring data).

Referring again to FIG. 7E, operation 406 may include operation 764 depicting assigning a weighted value to result data received from each of the interface devices. For example, FIG. 3 shows executed subtask result data receiving and weighting module 364 assigning a weighted value (e.g., a value score of 0.1 to 1.0 for each result data, based on a factor, e.g., the type of device (e.g., digital cameras are weighted higher than smartphones, an iPhone with an 8 megapixel camera is weighted higher than an iPhone with a 3 megapixel camera) to result data (e.g., image data) received from each of the interface devices (e.g., multiple iPhones and cameras).

Referring again to FIG. 7E, operation 764 may include operation 766 depicting assigning a weighted value to result data received from each of the interface devices based on a property of the interface devices. For example, FIG. 3 shows executed subtask result data receiving and property-based weighting module 366 assigning a weighted value (e.g., a value score from 1 to 100) to result data (e.g., loudness data) received from each of the interface devices (e.g., a Sony personal recorder and a Samsung Galaxy S II) based on a property of the interface devices (e.g., a sensitivity of the microphone used to record the loudness).

Referring again to FIG. 7E, operation 766 may include operation 768 depicting assigning a weighted value to result data received from each of the interface devices based on a particular status of the interface devices. For example, FIG. 3 shows executed subtask result data receiving and status-based weighting module 368 assigning a weighted value (e.g., a value score of 0 to 10,000) to result data (e.g., loudness data) received from each of the interface devices (e.g., an iPhone, a BlackBerry Torch, and an HTC Evo) based on a particular status of the interface devices (e.g., a proximity to the stage of the concert whose loudness is being measured).

Referring again to FIG. 7E, operation 766 may include operation 770 depicting assigning a weighted value to result data received from each of the interface devices based on a particular characteristic of the interface devices. For example, FIG. 3 shows executed subtask result data receiving and characteristic-based weighting module 370 assigning a weighted value (e.g., a value score of 0.1 to 1.0 for each result data, based on a factor) to result data (e.g., cellular network upload speed data) received from each of the interface devices (e.g., a Samsung Epic Touch 4G, a Samsung Galaxy S II 4G) based on a particular characteristic (e.g., has a 4G antenna) of the interface devices.

Referring again to FIG. 7E, operation 764 may include operation 772 depicting assigning a weighted value to result data received from each of the interface devices based on a communication network used to transmit the result data. For example, FIG. 3 shows executed subtask result data receiving and communication network based weighting module 372 assigning a weighted value (e.g., a value score of 0.1 to 1.0 for each result data, based on a factor) to result data (e.g., cellular network upload speed data) received from each of the interface devices (e.g., ten iPhone 4S devices) based on a communication network used to transmit the result data (e.g., different weights for Sprint 4G network, AT&T 3.5G network, EDGE network).

Referring again to FIG. 7E, operation 764 may include operation 774 depicting combining the weighted values of each of the received result data to obtain a result score. For example, FIG. 3 shows result data weighted value combining module 374 combining the weighted values (e.g., adding the weights) of each of the received result data (e.g., image data) to obtain a result score (e.g., weights (on a 1-100 scale) of 60, 40, 75, 85, and 60 result in a result score of 300).

Referring again to FIG. 7E, operation 764 may further include operation 776 depicting generating a result of the task of acquiring data when the result score exceeds a particular threshold value. For example, FIG. 3 shows result generating upon threshold result score data receiving module 376 generating a result (e.g., a 360-degree image) of the task of acquiring data (e.g., obtain a 360-degree picture of Times Square) when the result score (e.g., a combined score of the weighted values of the result data) exceeds a particular threshold value (e.g., 300, but the value could be static or dependent upon conditions).

Referring now to FIG. 7F, operation 406 may include operation 778 depicting polling the two or more interface devices to which the at least one of the one or more subtasks are transmitted for result data. For example, FIG. 3 shows executed subtask result data polling module 378 polling (e.g., sending out a transmission at intervals that is configured to be received by one or more devices, whose number and detail may be known or unknown at the time of sending the transmission) the two or more interface devices (e.g., the iPhone 4 and the Blackberry Bold) to which the at least one of the one or more subtasks (e.g., “determine the pollen count in your location”) are transmitted for result data (e.g., pollen count data).

Referring again to FIG. 7F, operation 778 may include operation 780 depicting polling the two or more interface devices to which the at least one of the one or more subtasks are transmitted for result data, at predetermined time intervals. For example, FIG. 3 shows executed subtask result data predetermined time interval polling module 380 polling the two or more interface devices (e.g., the ASUS Transformer tablet and the HP Touchpad Tablet) to which the at least one of the one or more subtasks (e.g., “take a picture facing west from your current location at the Space Needle”) are transmitted for result data (e.g., image data), at predetermined time intervals (e.g., every 60 seconds).

Referring again to FIG. 7F, operation 778 may include operation 782 depicting polling the two or more interface devices to which the at least one of the one or more subtasks are transmitted for result data, each time a result data is received. For example, FIG. 3 shows executed subtask result data polling on receipt of result data polling module 382 polling the two or more interface devices (e.g., a Dell laptop and an ASUS EeePc) to which the at least one of the one or more subtasks (e.g., “determine unsecured wireless network availability in your area”) are transmitted for result data, each time a result data is received (e.g., when data is received from the Dell laptop, the ASUS EeePc, as well as other devices, are polled for their data).

Referring again to FIG. 7F, operation 778 may include operation 784 depicting polling the two or more interface devices to which the at least one of the one or more subtasks are transmitted for result data, at time intervals based on previously received result data. For example, FIG. 3 shows executed subtask result data result-based time interval polling module 384 polling the two or more interface devices (e.g., the Amazon Kindle Fire and the Nook Color) to which the at least one of the one or more subtasks (e.g., “determine the brightness in the Barnes and Noble bookstore at your location”) are transmitted for result data, at time intervals based on previously received result data (e.g., the polling may occur once an hour regularly, but when outlier data is received, the time intervals decrease to once every ten minutes in order to track possible abnormalities).

Referring again to FIG. 7F, operation 778 may include operation 786 depicting polling the two or more interface devices to which the at least one of the one or more subtasks are transmitted for result data, at time intervals based on a performance of a communication network. For example, FIG. 3 shows executed subtask result data communication-network based time interval polling module 386 polling the two or more interface devices (e.g., a Nokia E5 and a Blackberry 8800) to which the at least one of the one or more subtasks (e.g., “capture image data at the coffee shop at your location”) are transmitted for result data, at time intervals based on a performance of a communication network (e.g., when the network is performing below average, the time intervals increase, to allow all the data to be received, and when the network is performing quickly, the time intervals decrease).

Referring now to FIG. 7G, operation 406 may include operation 788 depicting broadcasting a signal requesting that discrete interface devices transmit result data corresponding to a result of an executed one or more subtasks. For example, FIG. 3 shows executed subtask result data request broadcasting module 388 broadcasting a signal (e.g., transmitting a request to one or more interface devices, whose specifications may be known or unknown, and in some instances, with no particular expectation for response, which many interface devices may be able to receive, although may be unable to decode or understand) requesting that discrete interface devices transmit result data corresponding to a result of an executed one or more subtasks (e.g., “determine the moonlight brightness at your location on Puget Sound”).

Referring again to FIG. 7G, operation 788 may include operation 790 depicting broadcasting a signal requesting that discrete interface devices transmit result data corresponding to a result of an executed one or more subtasks to a predetermined location. For example, FIG. 3 shows executed subtask result data predetermined location request broadcasting module 390 broadcasting a signal requesting that discrete interface devices (e.g., an iPhone 4S and a Google Nexus phone) transmit result data corresponding to a result of an executed one or more subtasks (e.g., “query the user how long the wait is for the movie you are currently standing in line for”) to a predetermined location (e.g., a server that is configured to receive result data).

Referring again to FIG. 7G, operation 790 may include operation 792 depicting broadcasting a signal requesting that discrete interface devices transmit result data corresponding to a result of an executed one or more subtasks to a predetermined location that is different from a broadcasting location. For example, FIG. 3 shows executed subtask result data predetermined different location request broadcasting module 392 broadcasting a signal requesting that discrete interface devices (e.g., the Samsung Epic Touch, the HTC Evo) transit result data corresponding to a result of an executed one or more subtasks (e.g., “determine how many cannoli are available at the nearest coffee shop to your location”) to a predetermined location (e.g., a location that is configured to receive result data) that is different than a broadcasting location (e.g., the computing device carrying out the broadcasting may be a remote computing device designed to broadcast signals, or depending on specific network details, may be a network broadcasting device designed to broadcast signals across a particular type of network).

Referring again to FIG. 7G, operation 788 may include operation 794 depicting broadcasting a signal configured to be recognized by particular interface devices of the two or more discrete interface devices, requesting that the particular interface devices transmit result data corresponding to a result of an executed one or more subtasks. For example, FIG. 3 shows executed subtask result data recognized transmission request broadcasting module 394 broadcasting a signal configured to be recognized by particular interface devices (e.g., all iPhones) of the two or more discrete interface devices (e.g., iPhones, Blackberries, iPad tablets), requesting that the particular interface devices transmit result data corresponding to a result of an executed one or more subtasks (e.g., “capture image data from Times Square at 6 pm”).

Referring again to FIG. 7G, operation 788 may include operation 796 depicting broadcasting a signal requesting that discrete interface devices complete previously transmitted one or more subtasks and further requesting that the said discrete interface devices transmit result data corresponding to a result of executed said previously transmitted one or more subtasks. For example, FIG. 3 shows executed subtask transmission request and subtask completion request broadcasting module 396 broadcasting a signal requesting that discrete interface devices complete previously transmitted

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “capable of being operably coupled”, to each other to achieve the desired functionality. Specific examples of operably coupled include but are not limited to physically mateable and/or physically interacting components and/or wirelessly interactable and/or wirelessly interacting components and/or logically interacting and/or logically interactable components.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. In addition, although various operational flows are presented in a sequence(s), it should be understood that the various operations may be performed in other orders than those that are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1.-156. (canceled)

157. A system, comprising:
a task portion two-or-more discrete interface device subtask acquiring module configured to acquire one or more subtasks that correspond to portions of a task of acquiring data requested by a task requestor, wherein the task of acquiring data is configured to be carried out by two or more discrete interface devices;
an absent knowledge of task and/or task requestor information subtask transmitting module configured to transmit at least one of the one or more subtasks to at least two of the two or more discrete interface devices, wherein the one or more subtasks are configured to be carried out in an absence of information regarding the at least one task and/or the task requestor; and
an executed subtask result data receiving module configured to receive result data corresponding to a result of an executed one or more subtasks.

158-168. (canceled)

169. The system of claim 157, wherein said absent knowledge of task and/or task requestor information subtask transmitting module comprises:
an incomplete information of task and/or task requestor subtask transmitting module configured to transmit at least one of the one or more subtasks to at least two of the two or more discrete interface devices, wherein the one or more subtasks are configured to be carried out with incomplete information regarding the task requestor and/or the task of acquiring data.

170. The system of claim 157, wherein said absent knowledge of task and/or task requestor information subtask transmitting module comprises:
a less information of task and/or task requestor subtask transmitting module configured to transmit at least one of the one or more subtasks to at least two of the two or more discrete interface devices, wherein the one or more subtasks are configured to be carried out with less information than would be present on a device carrying out the task of acquiring data.

171. The system of claim 157, wherein said absent knowledge of task and/or task requestor information subtask transmitting module comprises:
an insufficient information of task and/or task requestor subtask transmitting module configured to transmit at least one of the one or more subtasks to at least two of the two or more discrete interface devices, wherein the one or more subtasks are configured to be carried out with insufficient information to carry out the task of acquiring data.

172. The system of claim 157, wherein said absent knowledge of task and/or task requestor information subtask transmitting module comprises:
an absent task information subtask transmitting module configured to transmit at least one of the one or more subtasks to at least two of the two or more discrete interface devices, wherein the one or more subtasks are configured to be carried out in an absence of information regarding the at least one task.

173. The system of claim 157, wherein said absent knowledge of task and/or task requestor information subtask transmitting module comprises:
an absent task requestor information subtask transmitting module configured to transmit at least one of the one or more subtasks to at least two of the two or more discrete interface devices, wherein the one or more subtasks are configured to be carried out in an absence of information regarding the task requestor.

174. The system of claim 157, wherein said absent knowledge of task and/or task requestor information subtask transmitting module comprises:
an absent knowledge of task requestor identity subtask transmitting module configured to transmit at least one of the one or more subtasks to at least two of the two or more discrete interface devices, wherein the one or more subtasks are configured to be carried out in an absence of information regarding the at least one task and/or without knowledge of an identity of the task requestor.

175. The system of claim 157, wherein said absent knowledge of task and/or task requestor information subtask transmitting module comprises:
an absent knowledge of task requestor objective subtask transmitting module configured to transmit at least one of the one or more subtasks to at least two of the two or more discrete interface devices, wherein the one or more subtasks are configured to be carried out in an absence of information regarding an objective of the task requestor.

176. The system of claim 157, wherein said absent knowledge of task and/or task requestor information subtask transmitting module comprises:
an absent knowledge of task purpose subtask transmitting module configured to transmit at least one of the one or more subtasks to at least two of the two or more discrete interface devices, wherein the one or more subtasks are configured to be carried out in an absence of information regarding a purpose of the at least one task.

177. The system of claim 157, wherein said absent knowledge of task and/or task requestor information subtask transmitting module comprises:
a communication network absent knowledge subtask transmitting module configured to transmit at least one of the one or more subtasks to at least two of the two or more discrete interface devices via a communication network.

178. The system of claim 177, wherein said communication network absent knowledge subtask transmitting module comprises:
a communication network having particular property subtask transmitting module configured to transmit at least one of the one or more subtasks to two or more discrete interface devices that are communicating via a communication network having a particular property.

179. The system of claim 178, wherein said communication network having particular property subtask transmitting module comprises:
a communication network having particular average connection speed subtask transmitting module configured to transmit at least one of the one or more subtasks to two or more discrete interface devices that are communicating via a communication network having a particular average connection speed.

180. (canceled)

181. The system of claim 178, wherein said communication network having particular property subtask transmitting module comprises:
a communication network having 4G connection subtask transmitting module configured to transmit at least one of the one or more subtasks to two or more discrete interface devices that are communicating via a 4G communication network.

182. The system of claim 178, wherein said communication network having particular property subtask transmitting module comprises:
a communication network having particular provider subtask transmitting module configured to transmit at least one of the one or more subtasks to at least two of the two or more discrete interface devices via a communication network operated by a particular network provider.

183. The system of claim 157, wherein said absent knowledge of task and/or task requestor information subtask transmitting module comprises:
a particular interface devices subtask transmitting module configured to transmit at least one of the one or more subtasks to a particular two or more discrete interface devices of the two or more discrete interface devices.

184. The system of claim 183, wherein said particular interface devices subtask transmitting module comprises:
a particular interface devices having at least one particular characteristic and/or status subtask transmitting module configured to transmit at least one of the one or more subtasks to two or more discrete interface devices having at least one of a particular characteristic and a particular status of the two or more discrete interface devices.

185. The system of claim 184, wherein said particular interface devices having at least one particular characteristic and/or status subtask transmitting module comprises:
a particular interface devices having at least one particular characteristic subtask transmitting module configured to transmit at least one of the one or more subtasks to two or more discrete interface devices having at least a particular characteristic.

186-187. (canceled)

188. The system of claim 184, wherein said particular interface devices having at least one particular characteristic and/or status subtask transmitting module comprises:
a particular interface devices having at least one particular status subtask transmitting module configured to transmit at least one of the one or more subtasks to two or more discrete interface devices having at least one particular status, of the two or more interface devices.

189-190. (canceled)

191. The system of claim 157, wherein said executed subtask result data receiving module comprises:
an executed subtask result data receiving and memory storing module configured to receive result data corresponding to a result of an executed one or more subtasks and storing the result data in a memory.

192. (canceled)

193. The system of claim 157, wherein said executed subtask result data receiving module comprises:
a two-or-more discrete interface devices executed subtask result data receiving module configured to receive result data corresponding to a result of an executed one or more subtasks from at least two of the two or more discrete interface devices.

194-195. (canceled)

196. The system of claim 193, wherein said two-or-more discrete interface devices executed subtask result data receiving module comprises:
a two or more discrete interface devices compressed result data receiving module configured to receive result data corresponding to a result of an executed one or more subtasks from at least two of the two or more discrete interface devices and compressing the result data received from the at least two of the two or more discrete interface devices.

197. The system of claim 157, wherein said executed subtask result data receiving module comprises:
an executed subtask result data receiving and collecting module configured to collect the received result data from at least two of the two or more discrete interface devices.

198. The system of claim 157, wherein said executed subtask result data receiving module comprises:
an executed subtask result data receiving and assembling module configured to assemble the received result data from at least two of the two or more discrete interface devices.

199. The system of claim 198, wherein said executed subtask result data receiving and assembling module comprises:
an executed subtask result data receiving and assembling into task result module configured to assemble the received result data from at least two of the two or more discrete interface devices into a result of the task of acquiring data.

200. The system of claim 198, wherein said executed subtask result data receiving and assembling module comprises:
an executed subtask result data receiving and assembling into partial task result module configured to assemble the received result data from at least two of the two or more discrete interface devices into a partial result of the task of acquiring data.

201. The system of claim 197, wherein said executed subtask result data receiving and collecting module comprises:
an executed subtask result data receiving, collecting, and compiling module configured to compile the received result data from at least two of the two or more discrete interface devices.

202. The system of claim 157, wherein said executed subtask result data receiving module comprises:
an executed subtask result data receiving and comparing module configured to compare the received result data from at least two of the two or more discrete interface devices.

203. The system of claim 202, wherein said executed subtask result data receiving and comparing module comprises:
an executed subtask result data receiving and comparing to expected value module configured to compare the received result data from at least two of the two or more discrete interface devices against at least one expected value of result data.

204. The system of claim 202, wherein said executed subtask result data receiving and comparing module comprises:
an executed subtask result data receiving and comparing against other received result data module configured to compare the received result data from at least two of the two or more discrete interface devices against each other.

205. The system of claim 204, wherein said executed subtask result data receiving and comparing against other received result data module comprises
an executed subtask result data receiving, comparing, and removing received result data module configured to compare the received result data from at least three of the two or more discrete interface devices and removing at least one of the at least three received results from the result data.

206. The system of claim 205, wherein said executed subtask result data receiving, comparing, and removing received result data module comprises:
an executed subtask result data receiving and comparing, and removing furthest away received result data module configured to remove at least one of the at least three received results from the result data, wherein the at least one removed result has the furthest numerical distance from an arithmetic mean of other received results.

207. The system of claim 157, wherein said executed subtask result data receiving module comprises:
an at least two interface device executed subtask result data receiving module configured to receive result data corresponding to a result of an executed one or more subtasks from at least two of the two or more discrete interface devices; and
a task result from result data generating module configured to generate a result of the task of acquiring data from the result data.

208. The system of claim 207, wherein said executed subtask result data receiving module further comprises:
a generated task result transmitting module configured to transmit the generated result of the task of acquiring data.

209. (canceled)

210. The system of claim 157, wherein said executed subtask result data receiving module comprises:
a transmitted subtask interface device identifying module configured to identify the two or more interface devices to which the at least one of the one or more subtasks is transmitted; and
a determining identified interface device executed subtask result data receiving module configured to determine when result data from the identified two or more interface devices corresponding to a result of an executed one or more subtasks is received.

211-216. (canceled)

217. The system of claim 157, wherein said executed subtask result data receiving module comprises:
a determining receipt of sufficient data based on particular number of interface devices result data receiving module configured to determine that sufficient result data has been received upon receipt of result data from a particular number of interface devices.

218. The system of claim 157, wherein said executed subtask result data receiving module comprises:
an executed subtask result data receiving and weighting module configured to assign a weighted value to result data received from each of the interface devices.

219. The system of claim 218, wherein said executed subtask result data receiving and weighting module comprises:
an executed subtask result data receiving and property-based weighting module configured to assign a weighted value to result data received from each of the interface devices based on a property of the interface devices.

220. The system of claim 219, wherein said executed subtask result data receiving and property-based weighting module comprises:
an executed subtask result data receiving and status based weighting module configured to assign a weighted value to result data received from each of the interface devices based on a particular status of the interface devices.

221. The system of claim 219, wherein said executed subtask result data receiving and property-based weighting module comprises:
an executed subtask result data and characteristic-based weighting module configured to assign a weighted value to result data received from each of the interface devices based on a particular characteristic of the interface devices.

222. (canceled)

223. The system of claim 218, wherein said executed subtask result data receiving and weighting module comprises:
a result data weighted value combining module configured to combine the weighted values of each of the received result data to obtain a result score; and
a result generating upon threshold result score data receiving module configured to generate a result of the task of acquiring data when the result score exceeds a particular threshold value.

224. The system of claim 157, wherein said executed subtask result data receiving module comprises:
an executed subtask result data polling module configured to poll the two or more interface devices to which the at least one of the one or more subtasks are transmitted for result data.

225. The system of claim 224, wherein said executed subtask result data polling module comprises:
an executed subtask result data predetermined time interval polling module configured to poll the two or more interface devices to which the at least one of the one or more subtasks are transmitted for result data, at predetermined time intervals.

226. (canceled)

227. The system of claim 224, wherein said executed subtask result data polling module comprises:
an executed subtask result data result-based time interval polling module configured to poll the two or more interface devices to which the at least one of the one or more subtasks are transmitted for result data, at time intervals based on previously received result data.

228. The system of claim 224, wherein said executed subtask result data polling module comprises:
an executed subtask result data communication network-based time interval polling module configured to poll the two or more interface devices to which the at least one of the one or more subtasks are transmitted for result data, at time intervals based on a performance of a communication network.

229. The system of claim 157, wherein said executed subtask result data receiving module comprises:
an executed subtask result data request broadcasting module configured to broadcast a signal requesting that discrete interface devices transmit result data corresponding to a result of an executed one or more subtasks.

230. The system of claim 229, wherein said executed subtask result data request broadcasting module comprises:
an executed subtask result data predetermined location request broadcasting module configured to broadcast a signal requesting that discrete interface devices transmit result data corresponding to a result of an executed one or more subtasks to a predetermined location.

231. The system of claim 230, wherein said executed subtask result data predetermined location request broadcasting module comprises:
an executed subtask result data predetermined different location request broadcasting module configured to broadcast a signal requesting that discrete interface devices transmit result data corresponding to a result of an executed one or more subtasks to a predetermined location that is different than a broadcasting location.

232. (canceled)

233. The system of claim 229, wherein said executed subtask result data request broadcasting module comprises:
an executed subtask transmission request and subtask completion request broadcasting module configured to broadcast a signal requesting that discrete interface devices complete previously transmitted one or more subtasks and further requesting that the said discrete interface devices transmit result data corresponding to a result of executed said previously transmitted one or more subtasks.
